(19) United States
(12) Patent Application Publication
(10) Pub. No.: US 2025/0104018 A1
(43) Pub. Date: Mar. 27, 2025

(54) MULTIVARIATE OPTIMIZATION OF COMPENSATION ANALYTICS

(71) Applicant: Penguin Benefits, Inc., San Jose, CA (US)

(72) Inventor: Chengchen Li, Redwood City, CA (US)

(73) Assignee: Penguin Benefits, Inc., San Jose, CA (US)

(21) Appl. No.: 18/892,847

(22) Filed: Sep. 23, 2024

Related U.S. Application Data
(60) Provisional application No. 63/540,118, filed on Sep. 25, 2023.

(51) Int. Cl. G06Q 10/1057

(52) U.S. Cl. CPC G06Q 10/1057

(57) ABSTRACT

Disclosed embodiments provide a processor-implemented method for optimization. A policy database including employee benefits information and compliance requirements is accessed and modeled via a set of usage configuration models. A multivariate empirical algorithm (MEA) is created, which arithmetically links the mathematical formulas. The MEA is based on a usage configuration model. Personal information is gathered from a user to create a user configuration and a first priority. The MEA is updated based on the user configuration. Compensation factors for which the user qualifies are identified by the MEA. The compensation factors are sequenced, based on a first priority. The compensation factors can be presented, to the user, based on the sequencing. The presenting includes a payment and duration estimate of each compensation factor that was identified. Instructions can be displayed for the user to apply for the compensation factors.

### RELATED APPLICATIONS

This application claims the benefit of U.S. provisional patent application “Multivariate Optimization of Compensation Analytics” Ser. No. 63/540,118, filed Sep. 25, 2023.

The foregoing application is hereby incorporated by reference in its entirety.

### FIELD OF ART

This application relates generally to optimization and more particularly to multivariate optimization of compensation analytics.

### BACKGROUND

The organized labor movement in the United States was born of the need to protect the common interest of workers. Disputes between laborers and employers or related businesses have occurred since before the country won its independence from England. In the 1630s, there was a fisherman's strike in Maine. Later, vehicle mechanics went on strike in New York City. Another recorded strike occurred in 1768 when New York journeymen tailors protested a wage reduction. Over time, as the Industrial Revolution changed the ratio of laborers to foremen and managers, groups of workmen began to band together into unions. The formation of the Federal Society of Journeymen Cordwainers (shoemakers) in Philadelphia in 1794 marked the beginning of sustained trade union organization among American workers. For those in the industrial sector, organized labor unions fought for better wages, reasonable hours, and safer working conditions.

The legality of labor unions was in dispute for many years. Most of the early strikes carried out by workers were considered illegal and generally failed in terms of gaining substantial changes in labor practices. Much of early American law was based on English common law. However, until it was unclear as to whether common law allowed for collective bargaining and labor unions. Different states reached different conclusions for many years. In 1842, the Massachusetts Supreme Judicial Court ruled that labor unions were legal, provided that they were organized for a legal purpose and used legal means to achieve their goals. The effects of this ruling were mixed, with some courts siding with the ruling, and others finding that collective bargaining for the purpose of raising wages was illegal, even though the labor union organizations themselves were legal.

In the mid-1800s, railroads began to grow rapidly and consolidate. As they grew, union organizations for railway workers, known as brotherhoods, sprang up as well. By the beginning of the 1900s, seventeen different railway brotherhoods were in operation. Most worked well with railway management. In the main, these unions were focused on providing insurance and medical packages for their members, as well as helping to set work rules involving seniority and procedures for handling grievances. Over time, the railway brotherhoods began to consolidate and wield considerable power. In 1916, The Adamson Act was passed, a result of a threatened national labor strike by railroad workers. This federal act provided ten hours of pay for an eight-hour day. Passage of the Adamson Act was the height of the brotherhoods' influence, and by the 1920s, these unions were largely stagnant.

The 1900s saw a sharp rise in labor unions across many industries. Building trades, coal miners, railway workers, seamstresses, telephone operators, cannery workers, dock workers, and farm workers all created unions to represent their constituencies. Their common aims were higher pay, restrictions on working hours and child labor, and improved working conditions and safety measures. Until the Great Depression, there were arguably as many failures as successes in disputes between labor and management. As both Republican and Democratic leaders sought to alleviate the economic crises that followed the 1929 stock market crash, several federal laws were passed to support labor union positions. Since that time, labor unions have continued to flourish and influence labor practices across the United States, even in work sectors that are not significantly unionized.

### SUMMARY

Today's work environment can include a vast array of benefits and compensation factors beyond monetary wages. Employers and managers have long sought to compensate workers with benefits such as pensions, paid vacation time, life insurance, maternity leave, health insurance, remote work opportunities, stock plans, and so on. In addition to benefits being added by private companies, local, state, and federal governments have been and continue to be involved in providing benefits such as Social Security and Medicare, as well as in creating a large number of laws and regulations intended to guarantee safe working environments, minimum wages, job security, union practices, and so on. The recent COVID-19 pandemic has resulted in further regulations and compensation factors at all governmental levels. In addition, private employers have added or modified compensation options as the modern workforce priorities have shifted. In many work sectors, the desired balance between work and life outside of work has changed significantly. Worker demand for greater flexibility and more options during significant life events has led to a series of updated rules and regulations in both the private and public sectors. As a consequence, understanding the compensation factors, qualifications, regulations, interactions between public and private benefits, and so on can be a daunting task. Varying laws between states, municipalities, and the federal government can make it difficult, even for a seasoned human resources or benefits specialist, to determine which benefits can be applied to different employees and situations. In these situations, offering equitable benefits can be problematic. When multiple compensation factors from multiple sources can be applied to the same employee situation, such as adopting a child or caring for an aging parent, determination of which compensation programs to use, and in what order, can be a daunting endeavor indeed.

Disclosed embodiments provide a processor-implemented method for optimization. A policy database including employee benefits information and compliance requirements is accessed and modeled via a set of usage configuration models. A multivariate empirical algorithm (MEA) is created, which arithmetically links the mathematical formulas. The multivariate empirical algorithm is based on a usage configuration model. Personal information is gathered from a user to create a user configuration and a first priority. The multivariate empirical algorithm is updated based on the user configuration. Compensation factors for which the user qualifies are identified by the MEA. The compensation factors are sequenced, based on a first priority. The compensation factors can be presented, to the user, based on the sequencing. The presenting includes a payment and duration estimate of each compensation factor that was identified. Instructions for the user to apply for the compensation factors can be displayed.

A processor-implemented method for optimization is disclosed comprising: accessing a policy database, wherein the policy database includes a plurality of policies, wherein each policy in the plurality of policies includes a plurality of benefit information and a plurality of compliance requirements, and wherein the plurality of benefit information is interrelated by the plurality of compliance requirements; modeling, with a plurality of mathematical formulas, using one or more processors, the plurality of benefit information and compliance requirements; creating a multivariate empirical algorithm (MEA), wherein the multivariate empirical algorithm arithmetically links one or more mathematical formulas within the plurality of mathematical formulas, and wherein the arithmetical links are based on a usage configuration within a plurality of usage configurations; gathering, from a user, personal information, wherein the personal information comprises a user configuration, and wherein the personal information includes a first priority; updating the multivariate empirical algorithm, wherein the updating is based on the user configuration; identifying, using one or more processors, one or more user-qualified compensation factors, wherein the identifying is based on the multivariate empirical algorithm; sequencing the one or more user-qualified compensation factors, wherein the sequencing optimizes the one or more user-qualified compensation factors for the first priority; and presenting, to the user, the one or more user-qualified compensation factors that were sequenced, wherein the presenting includes a visual demonstration of a payment estimate and a duration estimate of each of the one or more user-qualified compensation factors, and wherein the visual demonstration includes a total benefit payment estimate and a total benefit time duration. In embodiments, the visual demonstration comprises a graph of the one or more user-qualified compensation factors. In embodiments, the presenting comprises alerting the user of unused user-qualified compensation factors. In embodiments, the plurality of usage configurations comprises a plurality of employer benefit policies. Some embodiments include revising, by the user, the personal information. Other embodiments include amending the visual demonstration, wherein the amending is responsive to the revising. Further embodiments include establishing a second multivariate empirical algorithm, wherein the second multivariate empirical algorithm arithmetically links one or more mathematical formulas within the plurality of mathematical formulas, and wherein the arithmetical links are dynamically updated based on the revising. Embodiments include renewing one or more mathematical formulas within the plurality of mathematical formulas. In embodiments, the renewing is based on a change in the plurality of benefit information. In embodiments, the renewing is based on a change in the plurality of compliance requirements.

Various features, aspects, and advantages of various embodiments will become more apparent from the following further description.

### BRIEF DESCRIPTION OF THE DRAWINGS

The following detailed description of certain embodiments may be understood by reference to the following figures wherein:

FIG. 1 is a flow diagram for multivariate optimization of compensation analytics.

FIG. 2 is a flow diagram for presenting to a user.

FIG. 3 is an infographic for multivariate optimization of compensation analytics.

FIG. 4 is an example of a graph.

FIG. 5 is an example of a mouse-over pop-up.

FIG. 6 is an example of a week summary.

FIG. 7 is an example of a graphical user interface.

FIG. 8 is an example of application steps.

FIG. 9 is a system diagram for multivariate optimization of compensation analytics.

### DETAILED DESCRIPTION

Our modern work world can include a plethora of benefits and compensation factors in addition to monetary wages. These can include paid benefits, unpaid job protected leave entitlement, and so on. Benefits, including pensions, paid vacation time, life insurance, maternity leave, health insurance, remote work options, and stock plans, have been offered at one time or another by businesses large and small. In addition to private company benefits, local, state, and the federal government provide benefits such as Social Security, Medicare, disability insurance, paid family medical leave, and unemployment insurance. Along with these programs, a large number of laws and regulations intended to guarantee safe working environments, minimum wages, job security, union practices, and so on have been created. Private employers have added or modified compensation options as workforce priorities have shifted. At the same time, employees' desired balance between work and life outside of work has changed. Demand for greater flexibility during life events has led to a series of updated rules and regulations in both the private and public sectors. Thus, understanding the current compensation factors available to any particular worker can be a difficult task. Varying laws in different states, municipalities, and the federal government can make determining which benefits apply a daunting task, even for a professional human resources or benefits specialist. It can be nearly impossible for a regular employee to evaluate these benefits. When multiple compensation factors from multiple sources can be applied to the same employee situation, such as adopting a child or caring for an aging parent, determining which compensation programs or job protected leave entitlements to use, and in what order, can be a monumental challenge. Often, benefits are “left on the table” as employees commonly fail to understand their full slate of entitlements, how one plan can affect benefits offered by other plans, or the necessary timing of actions that must be taken to claim a plurality of plans for which the employee is entitled.

Techniques for optimization are disclosed. A policy database which includes a plurality of policies is accessed. Each policy includes a plurality of benefit information and a plurality of compliance requirements. The benefit information is interrelated by the compliance requirements. The benefit information can also be interrelated by an employer's benefits policy. The benefit information and the compliance requirements are modelled, using one or more processors, with a plurality of mathematical formulas. A multivariate empirical algorithm (MEA), which arithmetically links the mathematical formulas, is created. The links within the MEA are based on a usage configuration. The usage configurations can describe various common employee compensation situations such as having a baby, recovering from a serious injury, or qualifying for paid family medical leave. The usage configurations can describe typical benefits associated with an industry, a specific employer, and so on. Personal information is gathered from a user. The personal information comprises a user configuration. The personal information includes a first priority. The first priority can specify importance of various benefits sought by the user such as maximum time off, maximum wage compensation, minimal out-of-pocket expense, and so on. The multivariate empirical algorithm is updated, based on the user configuration. The updating can reflect the user's specific benefit eligibility. The multivariate empirical algorithm identifies, using one or more processors, one or more user-qualified compensation factors. The user-qualified compensation factors can comprise company, union, group insurance, local, state, and/or federal programs for which the user qualifies considering the benefit information, requirements, and personal information gathered. The user can generate and save multiple versions of the MEA, based on alternate priorities, timing, and so on. The user-qualified compensation factors, which optimizes the user-qualified compensation factors for the first priority, can be sequenced. The user-qualified compensation factors are presented to the user via a graphical user interface (GUI). The presenting includes a graph which comprises a visual demonstration of a payment estimate and a duration estimate of each of the one or more user-qualified compensation factors. The visual demonstration includes a total benefit payment estimate and a total benefit time duration.

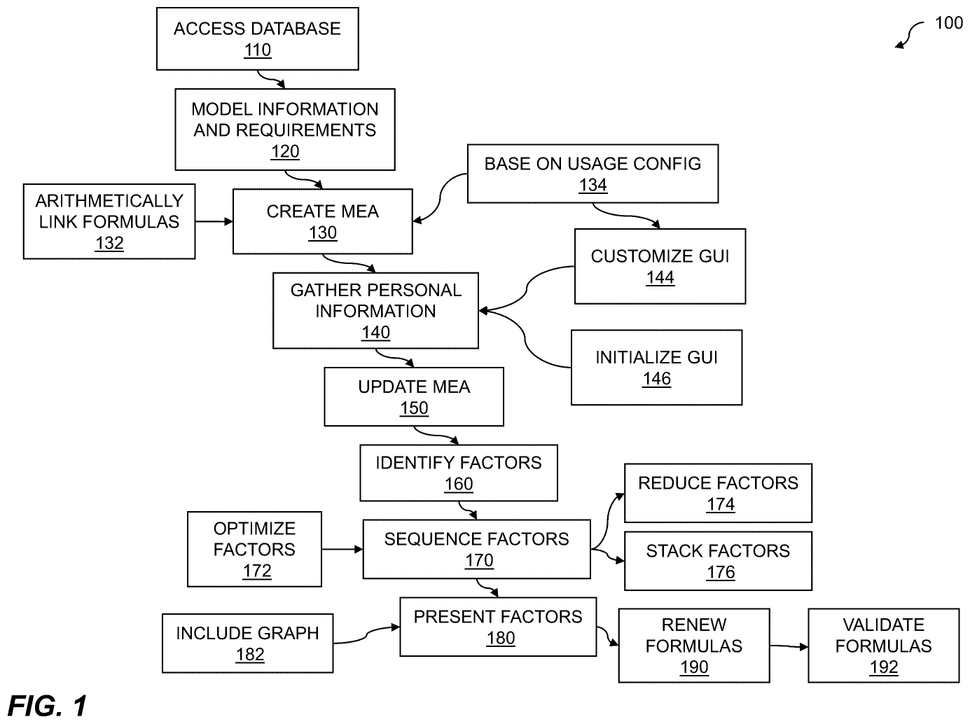

FIG. 1 is a flow diagram 100 for multivariate optimization of compensation analytics. The flow 100 includes accessing 110 a policy database. The policy database includes a plurality of policies. The policies can relate to wages and tips; regular pay; overtime; holiday pay; hazard pay; commissions; bonuses; full-time, part-time, and temporary employee definitions; exempt and non-exempt employee status; tax policies; health, life, and disability insurance options; retirement plans; time off; flexible work hours; on-campus and off-campus employment; education assistance; wellness programs; and so on. Each policy in the plurality of policies includes a plurality of benefit information and a plurality of compliance requirements. The benefit information can also be interrelated by an employer's benefits policy. In embodiments, the compliance requirements include eligibility requirements. The compliance requirements can include any combination of age restrictions, covered employee definitions, federal and state definitions of employee status, family and medical leave rules, union rules, and so on. In embodiments, the plurality of benefit information and the plurality of compliance requirements include one or more private employer benefit plans, one or more local benefit plans, one or more state benefit plans, one or more federal benefit plans, one or more union plans, or a combination thereof. The plurality of benefit information is interrelated by the plurality of compliance requirements. In a usage example, interrelated benefit information and compliance requirements can include restrictions on a leave of absence. These benefit restrictions can be based on a geographic location, earnings level, employee grouping (such as job grade), and so on. The one or more private employer benefit plans can be administered by the private employer. The private employer benefit plans can be purchased from a private insurance company. The policy database can include templates which can allow users to create customized benefits policies from the plurality of policies.

The flow 100 includes modeling, with a plurality of mathematical formulas, using one or more processors, the plurality of benefit information and compliance requirements 120. The modeling can represent, in mathematical equations, relevant benefit information and related compliance requirements. The mathematical formulas can contain any number of variables, including a projected obstetric delivery date, time employed, salary level, employment position or class, geographic location, local/state/federal restrictions, and so on pertaining to the benefit modeled. The mathematical formulas can be combined to determine eligibility, application timing, length of benefits, dollar values of benefits, and so on. Regulations or compensation programs can be updated by private employers and/or regulatory entities. Thus, the benefit information and compliance information can change. Embodiments include renewing the one or more mathematical formulas within the plurality of mathematical formulas. In embodiments, the renewing is based on a change in the plurality of benefits information. In other embodiments, the renewing is based on a change in the plurality of compliance requirements.

The flow 100 can include creating 130 a multivariate empirical algorithm (MEA). The MEA can include a plurality of formulas that calculate industry, state, or federal compensation factors. The formulas can be filtered out or selected for use based on compensation factors made available by the employer or the location in which the user lives or works. The multivariate empirical algorithm arithmetically links one or more mathematical formulas 132 within the plurality of mathematical formulas. The arithmetical links are based on a usage configuration 134 within a plurality of usage configurations. A usage configuration can include policies, benefits, restrictions, rules, compliance requirements, employee types, and so on that pertain to potential benefits. A library of usage configurations can be described and stored based on widespread employee situations. For example, descriptions can be built for salaried full-time employees, part-time swing-shift employees, sales employees working on commission, full-time employees with chronic illnesses, and so on. In embodiments, the plurality of usage configurations comprises a plurality of employer benefit policies. The employer benefits can include paid time off, bonding leave, maternity leave, paternity leave, job protection, sick leave, disability, and so on. In other embodiments, the usage configuration within the plurality of usage configurations pertains to an employer or leave administrator. In further embodiments, the leave administrator includes an insurance company or a third-party leave administrator. The number of mathematical formulas included in the MEA can be restricted to ensure that only those mathematical formulas that relate to a selected usage configuration are included. In a usage example, private employer A can create a usage configuration which restricts the MEA to only those benefits employer A provides, in addition to state and/or federal benefits available to its employees. In another usage example, an employer in the health insurance industry can create a usage configuration that describes typical benefits associated with employers in that industry. In embodiments, the multivariate empirical algorithm includes a theoretical algorithm.

The flow 100 can include gathering 140, from a user, personal information. In embodiments, the gathering includes a graphical user interface (GUI). A GUI can be a system of interactive visual components, such as input fields, icons, cursors, buttons, file folders, arrows, menus, dialog boxes, toolbars, and so on, used by computer software to gather information. The visual objects represent actions that can be taken by the user and can change color, size, or visibility as the users interact with them. The GUI can be branded for various employers, insurance companies, and so on. In embodiments, the GUI includes a series of questions to be answered by the user. The questions can include basic demographic information such as name, birthdate, due date, gender, parental role, employer, job title, marital status, residency status, dependents, and so on. In embodiments, the personal information that was gathered is not personally identifiable information (PII). The user can answer questions such that no PII is collected. For example, information can be collected to determine eligibility requirements for various benefits without collecting information such as a name, street address, social security number, and so on.

The personal information comprises a user configuration. The answers to the question above can be included in the user configuration. The personal information includes a first priority. The first priority can be included in the user configuration. For instance, a user may want to maximize the amount of monetary compensation, even if the number of days out of the office is reduced. Another user may favor the reverse, so that the number of protected days away from a job is maximized, even if more days are unpaid. In embodiments, the first priority includes an income level, time duration, or a combination of user-qualified compensation factors. In embodiments, the first priority is assumed. If the user does not specify a first priority through the GUI, a first priority can be assumed, such as maximizing time off, maximizing compensation, and so on. Other priorities can be made available to the user as alternatives. In some embodiments, the gathering includes a second priority. The user can choose to set up multiple scenarios with different priorities assigned to each and then compare them in later steps. The results of the gathering can be stored in the user configuration. An employer can include employment status, income level, job title, and other information in the user configuration. Embodiments include revising, by the user, the personal information. The user can re-enter data through the GUI, or come back to the GUI at a later time to change data that was associated with his or her user configuration.

The flow 100 includes customizing the GUI 144. The customizing is based on the usage configuration. Thus, the GUI can be customized to only gather relevant data to a specific employment situation. For example, a private employer can customize the GUI to only gather data relevant to their benefit plans offered. The GUI can make different options available based on the employer or agency deploying the GUI. The GUI can make more or fewer compensation factors available if the system is deployed as a standalone apart from any particular employer.

In embodiments, the gathering is accomplished by a private employer, a leave administrator, an application programming interface (API), a data feed, or any combination thereof. The API can create a data connection to a private employer, leave administrator, or another third party to supply the personal information. The data feed can be a file or stream of data from a private employer, leave administrator, or another third party to accomplish the gathering. Any of the aforementioned methods of accomplishing the gathering of personal information can be combined. The GUI can be initialized 146. The initializing can insert a default answer into one or more fields of the GUI. For example, the default answer to a work schedule prompt can be Monday to Friday, 8 hours a day, with input options available for the user to enter scheduled work hours for each day of the week. Embodiments include initializing the GUI, wherein the initializing includes one or more default answers to one or more questions in the series of questions.

The flow 100 includes updating the multivariate empirical algorithm 150. The updating is based on the user configuration. The selections made by the user and stored in the user configuration can be used to further refine which mathematical formulas are used within the MEA for the user, and which formulas are not. For example, a user's input related to their parental role (e.g., birthing parent, non-birthing parent, adoptive parent) can be used to determine the possible causes for taking their leave such as medical leave or bonding leave. In another example, the user's job grade or group of employment may determine which set of employer's benefits policies to apply. As previously described, the selections made by the user can be accomplished with the GUI. The selections can cause the GUI to ask for different inputs from the user. In response, the MEA can include or remove certain formulas related to those benefits. Including or removing the formulas can be accomplished by linking or unlinking formulas in the MEA, respectively. Embodiments include saving the MEA. The MEA that resulted from the set of responses from the user can be stored in memory, on a hard drive, in the cloud, and so on. The MEA can be accessed by the user at any time. As described earlier, the user can update the personal information. For example, a user can enter personal information that results in a first MEA. The personal information can be updated, resulting in second MEA. The first MEA can be compared with the second MEA. Multiple scenarios with multiple MEAs can be saved and compared so that the user can finetune the benefits and leave dates he or she desires. The various MEAs can be used to present options to the user and to compare plan scenarios.

The flow 100 includes identifying, using one or more processors, one or more user-qualified compensation factors 160. The identifying is based on the multivariate empirical algorithm. The user configuration can be combined with the MEA to select, from the policy database, the policies, compensation options, and related compliance requirements that can be applied to the user's particular circumstances. For example, an employee adopting a child while working for a company based in California can have a specific set of company, state, and federal compensation factors, which can be compensation options, available to them. These options can be different if the employee worked for a company based in Ohio. A part-time worker for a fast-food chain in Michigan can have a different set of compensation factors than a full-time union worker in the same state, and so on.

The flow 100 includes sequencing the one or more user-qualified compensation factors 170. Some user configurations can result in multiple compensation programs being available, such as medical and bonding leave during the birth of a child. Properly sequencing the order of the one or more user-qualified compensation factors can influence which benefits the user actually receives. Company policies and programs can overlap with state or federal programs. In some configurations, the employer may limit the amount of time off or may extend it. In some configurations, time off for medical recovery from giving birth can be combined with bonding compensation programs, and so on. In some circumstances, the order in which the compensation programs are applied can impact the total amount of time off available to the user, or the total monetary compensation available. The sequencing optimizes the one or more user-qualified compensation factors 172 for the first priority. The MEA calculations can be used to set an order in which the user-qualified factors are applied. The order in which benefits are applied can affect, maximize, etc. the total benefit received by the user. The sequencing can change based on the first priority.

As described above, the gathering can include a second priority. The user can select the second priority for the sequencing. Some users can choose to maximize the number of days that can be spent out of the office. Other users can choose to maximize the amount of monetary compensation or minimize the number of unpaid days, and so on. The sequencing can include which party is paying for each compensation factor, in part or in whole. For example, a particular compensation program might include a state paying for the first 60% of regular wages during the first six weeks of time off, followed by an insurance company paying an additional 6.66% during the same six weeks, followed by a private employer program paying a full salary for the next three weeks. In the above example compensation program, the final two weeks of the user's time off might be unpaid, but the user's job is still protected. The sequencing can take into account more than one priority. As described above, the user can define a second priority. In some embodiments, the sequencing optimizes the one or more user-qualified compensation factors for the first priority before the second priority.

The flow 100 includes reducing the one or more user-qualified compensation factors 174. In some cases, being eligible for and applying for a particular state, federal or union benefit can impact the qualification for related private group insurance benefit or employer programs, and so on. For example, if an employee takes a certain time off benefit, they may no longer be eligible for a different time off benefit from the employer, state, and so on. In embodiments, the sequencing comprises reducing the one or more user-qualified compensation factors, wherein at least two user-qualified compensation factors in the one or more user-qualified compensation factors are offset. A second MEA can be combined with a separate set of user priorities to allow the user to compare the outcomes of different scenarios. In some embodiments, the identifying and the sequencing are based on the second MEA. For instance, a user can compare prioritizing time away from the office with prioritizing the number of paid days off, and so on. The flow 100 includes stacking the one or more user-qualified compensation factors 176. In some cases, being eligible for and applying for a particular state, federal, or union benefit can be additive to other related private group insurance benefit or employer programs, and so on. In embodiments, the sequencing comprises stacking the one or more user-qualified compensation factors, wherein at least two user-qualified compensation factors in the one or more user-qualified compensation factors are overlapped. For example, in certain circumstances, an employee may qualify for multiple financial benefits at the same time when taking a medical leave of absence. In such cases, the various overlapping benefits can be stacked to show the total benefit received. The total benefit can be distributed over a specified time period. The specified time period can include a portion that includes overlapping benefits and a portion of non-overlapping benefits. This can be the case where one benefit has a longer duration than another.

The flow 100 includes presenting, to the user, the one or more user-qualified compensation factors 180 that were sequenced. The presenting can include the list of user-qualified compensation factors. The factors can be listed in sequence order that can be determined by the MEA calculations. The presenting includes a visual demonstration of a payment estimate and a duration estimate of each of the one or more user-qualified compensation factors. The presenting can include a graph 182. In embodiments, the visual demonstration comprises a graph of the one or more user-qualified compensation factors. The graph can display time in days, weeks, months, payroll periods, and so on, and can present compensation factors in different colors or patterns. The selected user priorities, related compensation factors, and total time related to the applied compensation factors can be used to determine the x- and y-scale options displayed on the graph, as well as the order in which the compensation factors are displayed. The user can move a mouse pointer over each compensation factor to view additional details related to that factor, such as the total number of days or weeks available, the start and end date, the amount of monetary compensation, and so on. The graph can include sources of monetary compensation, including employer, local, state, federal, or union programs involved. The related qualifications, policies, and restrictions can be displayed beside each factor; can be presented as a drop-down list, text, or table; can be shown in a separate detail page; can include a details window; and so on. The visual demonstration can include any combination of the aforementioned components.

The visual demonstration includes a total benefit payment estimate and a total benefit time duration. The graph, text, table, etc. can include the total amount of job-protected time available, with or without monetary compensation. The presenting can display a to-do list with tasks such as filing for benefits, noting deadlines for filing, and so on. This information can be displayed alongside the graph, table, text, etc. or on a separate display page. The presenting can be based on a mobile device, such as a phone, smartphone, tablet, and so on. The presenting can be based on a computer, laptop, server, etc. Different visual demonstrations can be available on different devices. For example, the visual demonstration can include a table on a mobile device while a graph can be included on a computer or laptop. In embodiments, the presenting comprises alerting the user of unused user-qualified compensation factors. For instance, a user may elect not to take all days off available under a particular compensation program. The presenting can make the user aware of the remaining benefits available. The information presented can be shared with others such as a manager of the employee, a human resource team, or a company. Any of these can advise the user based on the information presented.

As described above and throughout, the user can revise the personal information at any time. For example, the user can change the expected delivery date of a baby or method of delivery. The revising of personal information can result in renewing formulas 190 to form a second MEA. The renewing formulas can be based on a change in the plurality of benefit information. The renewing formulas can be based on a change in the plurality of compliance requirements. As regulations are updated or compensation programs are modified, created, etc., the MEA can include the updated mathematical formulas that model how the new compensation factors are expected to perform. When users, employers, and regulatory bodies employ the new regulations and programs in practice, the actual results may vary, leading to updates of the associated MEA formulas. Some embodiments include validating 192 the mathematical formulas, wherein the validating includes a database of established benefit scenarios. A set of known benefit scenarios and the correct answers to specific benefit questions can be created and used to validate changes made to benefit or compliance formulas before they are released for use by employers and employees.

Some embodiments include establishing a second multivariate empirical algorithm, wherein the second multivariate empirical algorithm arithmetically links one or more mathematical formulas within the plurality of mathematical formulas, and wherein the arithmetical links are dynamically updated based on the revising. The second MEA can be combined with a separate set of user priorities to allow the user to compare the outcomes of different scenarios. For example, a user can prioritize using one benefit over another when both benefits are not allowed to be used at the same time. The visual demonstration can change to show the results of the second MEA. In embodiments, the presenting is based on choosing, by the user, between the MEA and the second MEA. Multiple scenarios with multiple MEAs can be saved and compared so the user can finetune the benefits he or she desires. A plurality of MEAs can be saved, and can be used to identify compensation factors, to sequence the compensation factors the presenting, to present the compensation factors to the user, etc. to compare benefit options. The user can toggle between results of the first MEA, the second MEA, and/or any other MEA to compare the resulting user-qualified compensation factors. Embodiments include amending the visual demonstration, wherein the amending is responsive to the revising. As the user updates information and various MEAs are updated, created, saved, displayed, etc., the presenting can show the set of user-qualified compensation factors associated with the selected MEA. The presenting can include any MEA to compare one set of compensation factors and user priorities to another. The comparison can be shown on a graph, table, text, and so on.

Further embodiments include tracking, by a payment tracker, payments collected from the one or more user-qualified compensation factors. The tracking can include comparing the payments collected from the one or more user-qualified compensation factors with a payment estimate of the one or more user-qualified compensation factors. Actual payments received can be displayed on the graph in comparison to the expected payments calculated by the MEA. Data can be received from an employer, insurance company, third party benefits administrator, state, or federal agency as compensation factors are fulfilled over time. The user can update payments that have been received. For example, monetary compensation related to a particular factor can be displayed on a graphic bar for the compensation factor using a different color or pattern, showing realized earnings as compared to predicted earnings, and so on. A vertical line can be used to show the current date as compared to the start and end dates of the various compensation factors. The user can move a mouse pointer over a particular graph element to display additional details of a compensation factor, including total compensation received, variances between expected and actual compensation, and so on.

When payments are actually received, the payment tracker can recalculate updated estimates for other benefits. For example, a private employer may offer a pay benefit to an employee with the expectation of additional pay from the state. Later, the actual state payment received may be less than what was anticipated. In this case, the employer plan may make up the unexpectedly lower state benefit. The payment tracker can then recalculate any number of user-qualified compensation factors. In this example, the payment tracker can determine any additional pay the employer should offer the employee to make up for the lack of funding from the state. In this way, the payment tracker can help the employer coordinate employee benefits with outside parties.

Various steps in the flow 100 may be changed in order, repeated, omitted, or the like without departing from the disclosed concepts. Various embodiments of the flow 100 can be included in a computer program product embodied in a non-transitory computer readable medium that includes code executable by one or more processors. Various embodiments of the flow 100, or portions thereof, can be included on a semiconductor chip and implemented in special purpose logic, programmable logic, and so on.

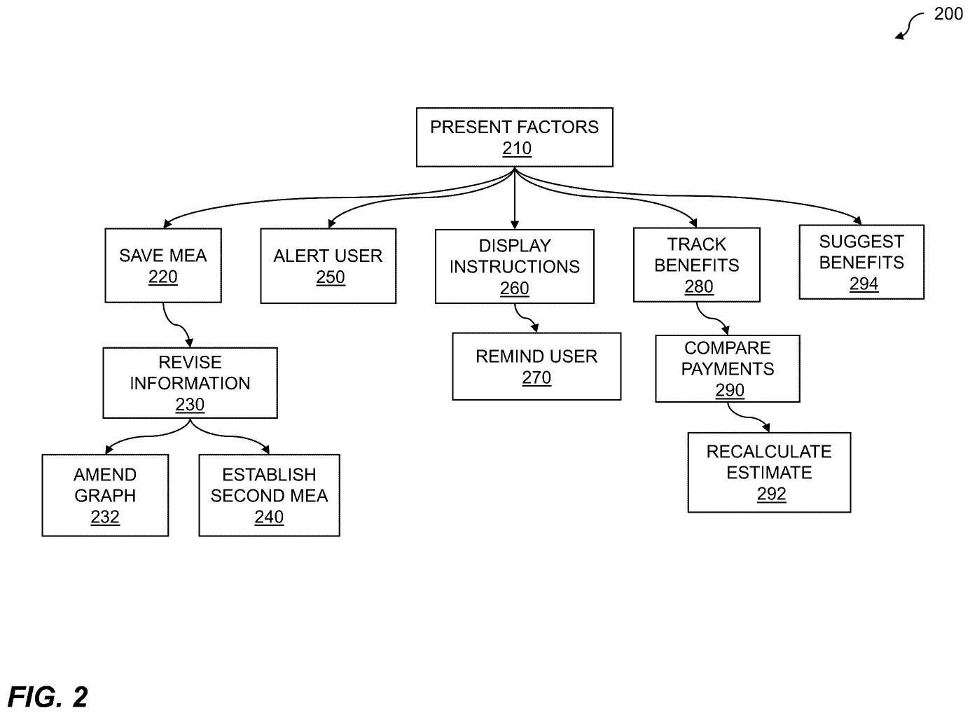

FIG. 2 is a flow diagram 200 for presenting to a user. The flow 200 can include presenting 210, to the user, the one or more user-qualified compensation factors that were sequenced. The presenting can include the list of user-qualified compensation factors. The factors can be listed in sequence order that can be determined by the MEA calculations. The presenting includes a visual demonstration of a payment estimate and a duration estimate of each of the one or more user-qualified compensation factors. In embodiments, the visual demonstration comprises a graph of the one or more user-qualified compensation factors. The visual demonstration includes a total benefit payment estimate and a total benefit time duration. The visual demonstration can include the total amount of job-protected time available, with or without monetary compensation. The presenting can display a to-do list with tasks such as filing for benefits, noting deadlines for filing, and so on. This information can be displayed alongside the graph, a table, text, etc. or on a separate display page. The presenting can be based on a mobile device, such as a phone, smartphone, tablet, and so on. The presenting can be based on a computer, laptop, server, etc. Different visual demonstrations can be available on different devices. For example, the presenting can include a table on a mobile device, while a graph can be included on a computer or laptop.

The flow 200 can include saving the MEA 220. The MEA that resulted from the set of responses from the user can be stored. The MEA can be stored in memory, on external storage, on a cloud server, or elsewhere. The MEA can be accessed at any time by the user. The MEA can be compared with one or more different MEAs created from updated responses that comprise a different plan scenario. Multiple scenarios with multiple MEAs can be saved and compared so the user can finetune the benefits he or she desires. Embodiments include saving the MEA.

The flow 200 can include revising the personal information 230. Recall that the personal information can include demographic information such as name, due date, parental role, employer, work schedule, employee group, dependents, and so on. In addition, the personal information can include a first priority for compensation features. Embodiments include revising, by the user, the personal information. The user can change the personal information at any time. For example, the user can change the expected delivery date of a baby or method of delivery. The changes can be made in the GUI interface as previously described. Recall also that the MEA can be updated based on a user configuration. The MEA can be modified based on the change to the updating of the personal information. The graph can be amended 232 in response to changing the personal information. Some embodiments include amending the visual demonstration, wherein the amending is responsive to the revising. As the user changes the personal information, the resulting MEA can be updated. The updated MEA can cause the graph to be amended to show the results of the updated MEA to the user. The amending can include one or more compensation factors. The amending can include changing a color or pattern of one or more compensation factors. The amending can include compensation amounts, timelines, sources of monetary compensation, job-protected time available, and so on. By amending the visual demonstration, the user is able to see how changing information and assumptions can change the compensation factors associated with their planning scenario.

The flow 200 can include establishing a second multivariate empirical algorithm 240. The revising of personal information can result in an updated MEA, which can be the second MEA. Some embodiments include establishing a second MEA, wherein the second multivariate empirical algorithm arithmetically links one or more mathematical formulas within the plurality of mathematical formulas, and wherein the arithmetical links are dynamically updated based on the revising. The user can select a second priority and compare the results of one priority option to another. Each priority choice can result in a different MEA. Each MEA can be stored and used to compare the various user-qualified compensation factors, the total monetary payments received, and total time off results to one another in later steps. For instance, a user can compare prioritizing time away from the office with prioritizing the number of paid days off, and so on. As previously described, one or more user-qualified compensation factors can be identified and sequenced. In embodiments, the identifying and the sequencing are based on the second MEA. Recall that the results of the sequencing can be presented to the user. In embodiments, the presenting is based on choosing, by the user, between the MEA and the second MEA. A plurality of MEAs can be saved, and can be used to identify, sequence, and present compensation factors to the user. This process can be helpful when comparing benefit plan options. Each option can be displayed as a graph and can be used to compare one set of compensation factors and user priorities to another.

The flow 200 can include alerting the user 250. In embodiments, the presenting comprises alerting the user of unused user-qualified compensation factors. For instance, a user may elect not to take all days off available under a particular compensation program. The presenting can make the user aware of the remaining benefits available. The remaining benefits can be financial, a range of days, and so on. As mentioned above and throughout, the user can select from multiple scenarios, based on different priorities resulting in different MEA calculations. Each scenario can be displayed as a visual demonstration, such as a graph, table, text, and so on. The visual demonstration can be used to compare one set of compensation factors and user priorities to another. The alerts can direct the user to attempt a different scenario to optimize their benefits. The alerts can comprise text, a mouse-over hover message, a report, a pop-up message, a text message, a phone call, or some other means to notify the user.

The flow 200 can include displaying instructions 260. Some embodiments include displaying instructions, to the user, wherein the instructions include one or more application steps, to be accomplished by the user, for the one or more user-qualified compensation factors that were sequenced. The one or more application steps can include other activities related to the one or more user-qualified compensation factors. For example, the displaying can include a reminder for a user to add a newborn to his or her health insurance policy within thirty days of birth. In embodiments, the one or more application steps include an order, wherein the order is based on the sequencing. As mentioned previously, the order in which user-qualified compensation factors are taken can have an impact on the total time off available or the total monetary results. The displaying can present instructions to the user on how to apply for each user-qualified compensation factor and the order in which the instructions can be followed. The order, when followed by the user, can result in maximization of benefits such as compensation, time off, and so on. The user instructions can include links to company web pages; state, federal, or union websites; etc. that contain additional information and/or online forms to apply for related compensation programs.

The flow 200 can include reminding the user 270. Some embodiments include reminding the user to accomplish the one or more application steps. The user can receive emails, texts, phone calls, and so on to remind them when and how to apply for specific compensation factors. The user can indicate when each instruction step is completed. The user can indicate the completion of the steps in a return email, by text, by logging into a software tool, and so on. The displaying can present the completed instructions in a list, in a text box, in a separate window, on a graph, etc., and can indicate a next instruction step to be taken.

The flow 200 can include tracking benefits 280. Some embodiments include tracking, by a payment tracker, payments collected from the one or more user-qualified compensation factors. Actual benefits received can be displayed on a graph in comparison to the expected benefits. The actual payments received can be self-reported by the user. The actual payments received can be obtained through an application programming interface (API) that can interface with a third-party paying a benefit. Compensation factor data can be received from an employer, state, federal agency, and so on as compensation factors are fulfilled over time. The flow 200 can include comparing payments 290. Some embodiments include comparing the payments collected from the one or more user-qualified compensation factors with a payment estimate of the one or more user-qualified compensation factors. For example, monetary compensation related to a particular factor can be displayed on a graph for the compensation factor using a different color or pattern, showing received earnings as compared to predicted earnings. A vertical line is used to show the current date as compared to the start and end dates of the various compensation factors. The user can move a mouse pointer over a particular graph element to display additional details of a compensation factor, including total compensation received, variances between expected and actual compensation, and so on. The graphic can be used by users and by employers to determine whether follow-up communications are needed, and so on.

The flow 200 can include recalculating the payment estimate 292. Some embodiments include recalculating the payment estimate of at least one user-qualified compensation factor. When payments are actually received, the payment tracker can recalculate estimates for other benefits. For example, a private employer may offer a pay benefit to an employee with the expectation of additional pay from the state. Later, the actual state payment received may be less than what was anticipated. In this case, the employer plan may make up the unexpectedly lower state benefit. The payment tracker can then recalculate any number of user-qualified compensation factors. In this example, the payment tracker can determine any additional pay the employer should offer the employee to make up for the lack of funding from the state. In this way, the payment tracker can help the employer coordinate employee benefits with outside parties. The flow 200 can include suggesting benefits 294. Recall that personal information and a first priority can be gathered from a user. In embodiments, the gathering is accomplished by a private employer, a leave administrator, an application programming interface (API), a data feed, or any combination thereof. The API can create a data connection to a private employer, leave administrator, or another third party to supply the personal information.

Other embodiments include suggesting benefits, to the user, wherein the suggesting is based on the gathering. In some cases, the user may not be aware of their eligibility for certain benefits. For example, the user may not be aware of state time off programs. These benefits can be highlighted to the user. In some cases, the user may not be aware of the availability or need for certain benefits. For example, the user can input relevant information regarding benefits such as time off due to a pregnancy. Based on this information, a suggestion can be made for the user to review or consider a new life insurance policy, to add a new child to a medical insurance policy, and so on. The suggesting can include adding benefits, excluding benefits, prioritizing benefits, and so on. The suggesting can maximize benefits for the user. The suggesting can be based on the first priority, the second priority, and so on. The suggesting can be based on a combination of two or more priorities.

Various steps in the flow 200 may be changed in order, repeated, omitted, or the like without departing from the disclosed concepts. Various embodiments of the flow 200 can be included in a computer program product embodied in a non-transitory computer readable medium that includes code executable by one or more processors. Various embodiments of the flow 200, or portions thereof, can be included on a semiconductor chip and implemented in special purpose logic, programmable logic, and so on.

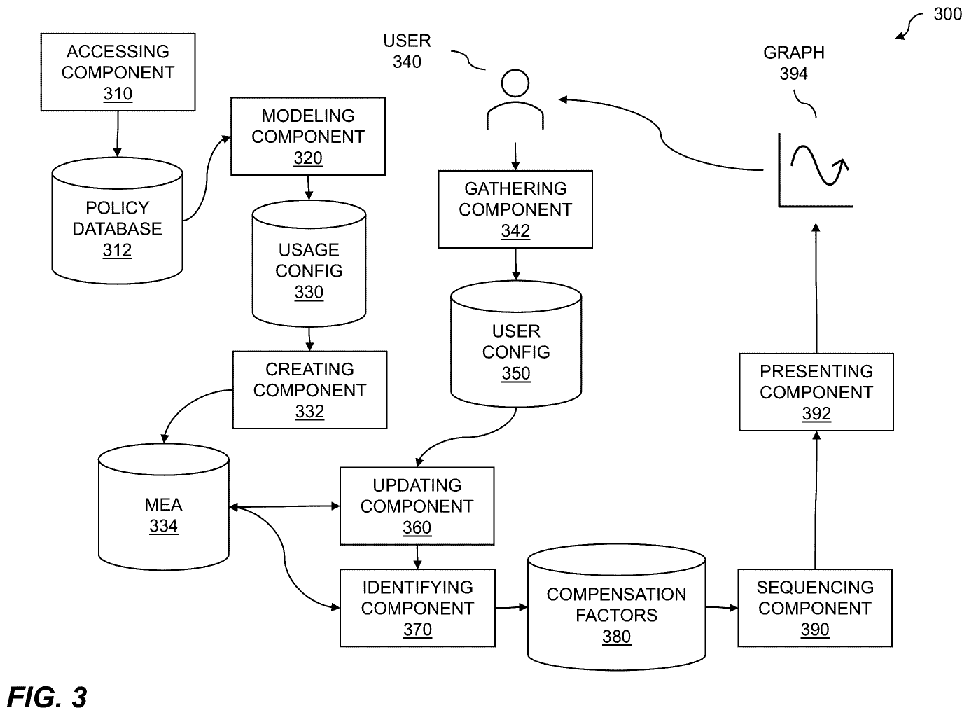

FIG. 3 is an infographic 300 for multivariate optimization of compensation analytics. As mentioned above and throughout, a policy database including benefit information, compliance requirements, and relationships between the benefits and compliance requirements can be accessed. Mathematical formulas can be generated to model each policy and to consider the compliance requirements associated with the benefits addressed by the policy. A multivariate empirical algorithm (MEA), which arithmetically links the plurality of mathematical formulas, can be created. The links within the MEA can be based on a usage configuration. The usage configurations can describe various common employee compensation situations, such as the birth or adoption of a child, recovery from a serious injury or a long-term illness, taking care of a family member, and so on. The usage configurations can describe typical benefits associated with an industry, a specific employer, and so on. Information can be gathered from a user and can be analyzed to create a user configuration. The gathering can be based on a graphical user interface (GUI). The user configuration can be based on more specific information from the user. The user can designate a priority for the user configuration which can be used to place compensation factors into an order that reflects the user preferences. The user configuration can be used to update the multivariate empirical algorithm (MEA) that links one or more mathematical formulas associated with user-qualified compliance factors arithmetically. The MEA can be used to identify and sequence user-qualified compliance factors into an order that optimizes the user configuration. The selected compliance factors that can display the compliance factors, requirements associated with each factor, and instructions to apply for each compliance factor, can be presented to the user. The presenting can include a graph that can display the various compliance factors over time. The graph can include compensation amounts, details about each compensation factor, the overlap of compensation factors, and so on. The graph can also track the actual compensation received versus the predicted amounts in terms of time, money, and so on. Thus, a user can determine the best combination of compensation factors for their situation, apply for the compensation factors in the appropriate order, and track the actual compensation results without having to understand all of the mathematical complexities of each compensation program or the ways in which company, state, federal, or union rules and policies affect each program. An employer can advise employees about various compensation options available to them, help them apply for chosen options, and track compensation as it is paid out. Problems in compensation can be quickly identified and addressed by the employer or the employee.

The infographic 300 can include an accessing component 310. The accessing component can include accessing a policy database 312. The policy database includes a plurality of policies. The policies can include instructions, information, regulations, rules, and so on. The polices can pertain to wages and tips; regular pay; overtime; holiday pay; hazard pay; commissions; bonuses; full-time, part-time, and temporary employee definitions; exempt and non-exempt employee status; tax policies; health, life, and disability insurance options; retirement plans; time off; flexible work hours; on-campus and off-campus employment; education assistance; wellness programs; and so on. Each policy in the plurality of policies includes a plurality of benefit information and a plurality of compliance requirements. In embodiments, the compliance requirements include eligibility requirements. The compliance requirements can include any combination of age restrictions, covered employee definitions, federal and state definitions of employee status, family and medical leave rules, union rules, and so on. In embodiments, the plurality of benefit information and the plurality of compliance requirements include one or more private employer benefit plans, one or more local benefit plans, one or more state benefit plans, one or more federal benefit plans, one or more union plans, or a combination thereof. The plurality of benefit information is interrelated by the plurality of compliance requirements. In a usage example, interrelated benefit information and compliance requirements can include restrictions on the leave. These restrictions can be based on an employee's geographic location, earnings level, employee grouping (such as job grade), and so on.

The infographic 300 can include a modeling component 320. The modeling component can include modeling, with a plurality of mathematical formulas, the plurality of benefit information and compliance requirements. The modeling can represent, in mathematical equations, relevant benefit information and related compliance requirements. The mathematical formulas can contain any number of variables pertaining to the benefit modeled including age, a projected obstetric delivery date, time employed, salary level, and so on. The mathematical formulas can be combined to determine eligibility, application timing, length of benefits, dollar values of benefits, and so on. A plurality of usage configurations 330 can be stored based on common employee situations. The usage configurations can include a selection of relevant benefit information and compliance requirements, and mathematical formulas that can be combined with user data to determine individual eligibility, length of benefits, dollar values of benefits, and so on. Any policy can change at any time. The mathematical formulas can be updated to stay coordinated with one or more changing policies. Some embodiments include renewing one or more mathematical formulas within the plurality of mathematical formulas. The renewing can be based on the benefit information, the compliance requirements, or other information associated with the policies. In further embodiments, the renewing is based on a change in the plurality of benefit information. In other embodiments, the renewing is based on a change in the plurality of compliance requirements. When the mathematical formulas are updated, a verification process can ensure proper modeling of the policy within many different user scenarios. Embodiments include validating the mathematical formulas, wherein the validating includes a database of established benefit scenarios. A set of known benefit scenarios and the correct answers to specific benefit questions can be created and used to validate changes made to benefits or compliance formulas before they are released for use by employers and employees. In embodiments, the plurality of usage configurations comprises a plurality of employer benefit policies. One or more usage configurations within a plurality of usage configurations can pertain to an employer or leave administrator. The leave administrator can include an insurance company or a third-party leave administrator.

The infographic 300 can include a creating component 332. The creating component can include creating a multivariate empirical algorithm (MEA). The MEA 334 can combine one, some, or all of the mathematical formulas according to a usage configuration. The multivariate empirical algorithm arithmetically links one or more mathematical formulas within the plurality of mathematical formulas. The arithmetical links are based on a usage configuration within a plurality of usage configurations. The MEA can include a plurality of formulas that calculate industry, state, or federal compensation factors. In embodiments, the multivariate empirical algorithm includes a theoretical algorithm. The theoretical algorithm can include data from outside the policies, user configurations, MEAs, etc. The MEA formulas can be filtered out or selected for use based on factors included in a specific usage configuration. Additional MEAs can be created, such as a second MEA, which can be based on other usage configurations or a change in data input by the user. The user can select the MEA, the second MEA, and so on that is most appropriate for his or her circumstances. The MEA formulas can represent a usage configuration of a specific employer. In embodiments, the usage configuration within the plurality of usage configurations pertains to an employer or leave administrator. In some embodiments, the leave administrator includes an insurance company or a third-party leave administrator.

The infographic 300 can include a gathering component 342. The gathering can include gathering, from a user, personal information. In embodiments, the gathering can include a graphical user interface (GUI). A GUI can be a system of interactive visual components for computer software, such as icons, cursors, buttons, file folders, arrows, menus, dialog boxes, toolbars, and so on. The visual objects can represent actions that can be taken by the user 340, and can change color, size, or visibility as the users interact with them. In embodiments, the GUI includes a series of questions to be answered by the user. The questions can include name, due date, parental role, dependents, employer, work schedule, employee group, etc. In embodiments, the gathering is accomplished by a private employer, a leave administrator, an application programming interface (API), a data feed, or any combination thereof.

In embodiments, the personal information that was gathered is not personally identifiable information (PII). To protect sensitive information, some or all PII can be withheld by the user, or not requested by the GUI. The personal information can comprise a user configuration. The personal information can include a first priority. The first priority can be set by the user. The user can use the GUI to set the first priority. The user configuration 350 can include the first priority. For instance, a user may want to maximize the amount of monetary compensation, even if the number of days out of the office is reduced. Another user may favor the reverse, so that the number of protected days away from a job is maximized, even if more days are unpaid. In embodiments, the gathering includes a second priority.

The infographic 300 can include an updating component 360. The updating component can include updating the multivariate empirical algorithm. The updating is based on the user configuration. The selections made by the user and stored in the user configuration can be used to further refine which mathematical formulas are used within the MEA for the user, and which formulas are not. The selections made by the user can be accomplished with the GUI. For instance, a user's input related to their parental role (e.g., birthing parent, non-birthing parent, adoptive parent, etc.) can be used to determine the possible causes for taking their leave such as medical leave or bonding leave. In another example, the user's job grade or group of employment may determine which set of employer's benefits policies to apply. In embodiments, selections made by the user cause the GUI to ask for different inputs from the user. In response, the MEA can include or remove certain formulas related to those benefits.

The infographic 300 can include an identifying component 370. The identifying component can include identifying, using one or more processors, one or more user-qualified compensation factors. The identifying is based on the multivariate empirical algorithm. In embodiments, the user configuration and the updated MEA can be used to identify one or more compensation factors 380 for which the user is qualified. The user configuration can be combined with the MEA to identify from the policy database the policies, compensation options, and related compliance requirements that can be applied to the user's particular circumstances. For example, an employee adopting a child while working for a company based in California can have a specific set of company, state, and federal compensation options available to them that can be different from the options if the employee worked for a company based in Ohio.

The sequencing component can include sequencing the one or more user-qualified compensation factors. Some user configurations can result in multiple compensation programs being available, such as medical and bonding leave during the birth of a child. Company policies and programs can overlap with state or federal programs. In some configurations, the employer may limit the amount of time off or may extend it. In some configurations, time off for medical recovery from giving birth can be combined with bonding compensation programs, and so on. In some circumstances, the order in which the compensation programs are applied can impact the total amount of time off available to the user, or the total monetary compensation available. The sequencing optimizes the one or more user-qualified compensation factors for the first priority. The MEA calculations can be used to optimize the order in which the user-qualified factors are applied, based on the first user priority.

The infographic 300 can include a presenting component 392. The presenting component can include presenting, to the user, the one or more user-qualified compensation factors that were sequenced. In embodiments, the presentation component can include the list of user-qualified compensation factors 380, listed in sequence order 390 that can be determined by the MEA calculations. The related qualifications, policies, and restrictions can be displayed beside each factor, can be presented as a drop-down list or a separate detail page, can be shown as a window displayed over the main graph, and so on. The presenting includes a visual demonstration of a payment estimate and a duration estimate of each of the one or more user-qualified compensation factors. The visual demonstration includes a total benefit payment estimate and a total benefit time duration. In embodiments, the visual demonstration comprises a graph of the one or more user-qualified compensation factors. A graph 394 displaying time in days, weeks, months, and so on can be presented along with each compensation factor shown in a different color or pattern, and so on. In embodiments, the user can move a mouse pointer over any compensation factor to view additional details related to that factor, such as the total number of days or weeks available, the start and end date, the amount of monetary compensation, and so on. The graph can include the sources of monetary compensation, including employer, local, state, federal, or union programs involved. The graph can include the total amount of job-protected time available, with or without monetary compensation. The presenting can include a table, text, and/or other ways of conveying the payment estimate and a duration estimate.

Further embodiments include displaying instructions, to the user, wherein the instructions include one or more application steps, to be accomplished by the user, for the one or more user-qualified compensation factors that were sequenced. The one or more application steps can include an order, wherein the order is based on the sequencing. Further embodiments include tracking, by a payment tracker, payments collected from the one or more user-qualified compensation factors. Other embodiments include comparing the payments collected from the one or more user-qualified compensation factors with a payment estimate of the one or more user-qualified compensation factors. Actual benefits received can be displayed on a graph in comparison to the expected benefits. Data can be received from an employer, state, or federal agency as compensation factors are fulfilled over time. When payments are actually received, the payment tracker can recalculate updated estimates for other benefits. For example, a private employer may offer a pay benefit to an employee with the expectation of additional pay from the state. Later, the actual state payment received may be less than what was anticipated. In this case, the employer plan may make up the difference between the anticipated payment benefit and the unexpectedly lower state benefit. The payment tracker can then recalculate any number of user-qualified compensation factors. In this example, the payment tracker can determine any additional pay the employer should offer the employee to make up for the lack of funding from the state. In this way, the payment tracker can help the employer coordinate employee benefits with outside parties.

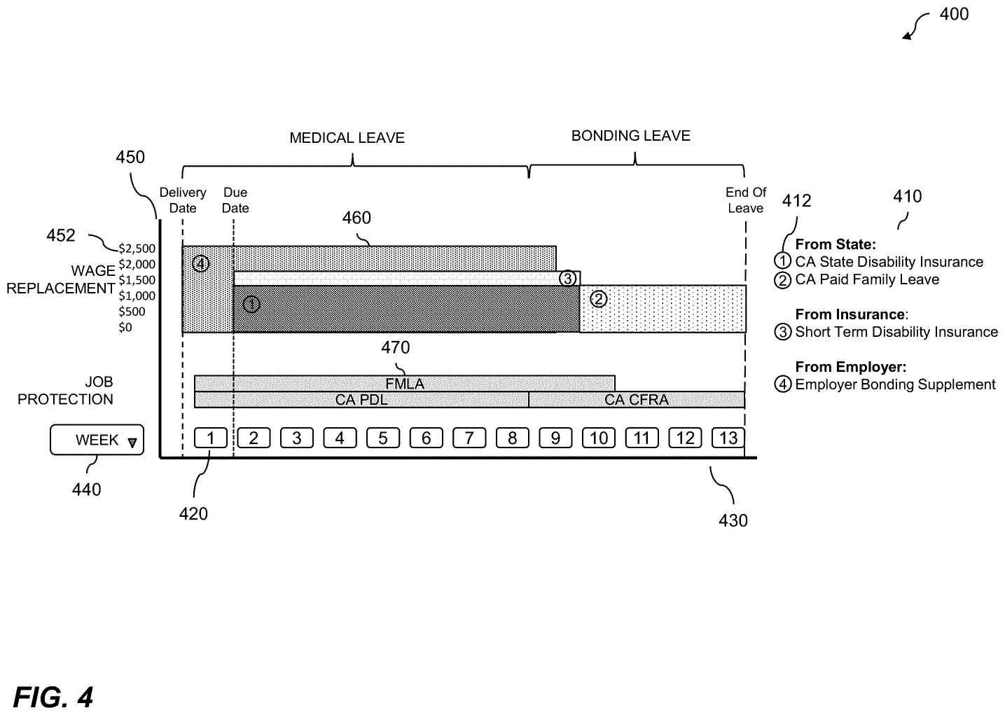

FIG. 4 is an example of a graph 400. Recall that the one or more user-qualified compensation factors can be presented to the user via a visual demonstration. In embodiments, the visual demonstration comprises a graph of the one or more user-qualified compensation factors. The example 400 can include the list of user-qualified compensation factors 410. Recall that one or more user-qualified compensation factors can be sequenced and that the sequencing can optimize the one or more user-qualified compensation factors for a first priority. In embodiments, the first priority includes an income level, time duration, or a combination of user-qualified compensation factors. The user-qualified compensation factors can be listed in a sequence order that can be determined by the MEA calculations. In the example 400, the list of compensation factors can be separated by source such as state, insurance, and employer. A number 412 can be associated with each compensation factor to indicate the priority sequence of each factor. The number can also be used as a key for the graph to indicate which compensation factor appears in each section of the graph. Colors or shading can be used as the key instead of numbers. For example, the Employer Bonding Supplement is numbered four and appears at the far-left center of the graph. In some embodiments, the qualifications, policies, and restrictions related to each compensation factor can be displayed beside each factor and can be presented as a drop-down list from the compensation factor label, as a separate detail page, as a window displayed over the main graph, and so on.

The selected user priorities, related compensation factors, and total time related to the applied compensation factors can be used to determine the x- and y-scale options displayed on the graph, as well as the order in which the compensation factors are displayed. In the example 400, the graph can display time periods 420 in weeks along the x-axis 430. Each week can be numbered, starting with the week in which the selected compensation factors begin to be paid to the user. The initial delivery date of the first compensation factor can be shown as the beginning of the first week of compensation and can be represented by a vertical dashed line. The due date for the first compensation factor (the employer bonding supplement) can be indicated as a vertical dotted line. The end-of-leave date can also be indicated as a vertical dashed line on the right side of the graph. In embodiments, the user can select different time periods 440 for the x-axis display. The time periods can be displayed in days, weeks, months, payroll periods, and so on. Depending on the total length of the compensation period, the graph can automatically be displayed using the time increment that covers the entire length of the compensation factors. The user can select different time periods dynamically, allowing for more or less detail to be displayed. Recall that the gathering can include a second priority. In embodiments, the sequencing optimizes the one or more user-qualified compensation factors for the first priority before the second priority. As a second priority is selected, the list of user-qualified compensation factors can change, as well as the graph to optimize for various scenarios specified by the user.

In the example 400, the y-axis 450 can describe two different graph sections. The upper section can indicate wage replacement in a currency such as dollars. The wage replacement currency scale is shown on the left at 452, and the various sources of compensation are shown as numbered bars 460 across the x-axis, which in the example 400 is shown in numbers of weeks. In some cases, the various sources of compensation can be offset. This can be due to policies for one compensation factor prohibiting simultaneous payments from other sources. In example 400, multiple sources of compensation are shown, but not all are additive. For example, payments from the Employer Bonding Supplement overlaps with payments from CA State Disability Insurance. In embodiments, the sequencing comprises reducing the one or more user-qualified compensation factors, wherein at least two user-qualified compensation factors in the one or more user-qualified compensation factors are offset. In other cases, the various sources of compensation can be additive, or stacked, where the policies allow. Thus, in other embodiments, the sequencing comprises stacking the one or more user-qualified compensation factors, wherein at least two user-qualified compensation factors in the one or more user-qualified compensation factors are overlapped.

The length of each graph bar can indicate the number of weeks for which the particular compensation factor pays out. For example, the employer bonding supplement, element number four, is shown as replacing $2,500 of wages for a period of eight weeks. In the first week, the entire $2,500 is paid by the employer from the employer bonding supplement source. In weeks two through eight, the CA state disability insurance pays the first $1,000 of compensation, short term disability insurance pays the next $500, and the employer bonding supplement pays the remaining $1,000. In week nine, the employer bonding supplement ends, resulting in a wage replacement of $1,500 from two sources. In weeks ten to thirteen, the remaining wage replacement of $1,000 is paid by the CA paid family leave compensation factor. In embodiments, the graph can be updated to show the same information on a daily basis when the user selects a daily time period. Any other time period can be selected and displayed on the graph.

In the example 400, the lower section of the graph can display job protection elements 470. The job protection elements can be seen as grey bars running along the x-axis. In the example graph, three separate job protection compensation elements are shown, each using a separate abbreviation. The California state pregnancy disability leave act is shown as CA PDL and extends from weeks one to eight. The California state family rights act is shown as CA CFRA and runs from weeks nine to thirteen. The federal family and medical leave act is shown as FMLA and runs from weeks one to ten. In some embodiments, each compensation factor can be shown in a different color or pattern, and so on. In some embodiments, one or more brackets can be used at the top of the graph to indicate the start and end point of general categories of time off, such as medical leave and bonding leave. As detailed below, the user can move a mouse pointer over each compensation factor to view additional details related to that factor, such as the total number of days or weeks available, the start and end date, the amount of monetary compensation, and so on. In other embodiments, the graphic can display education class schedules and deadlines alongside employer or public program compensation or time available.

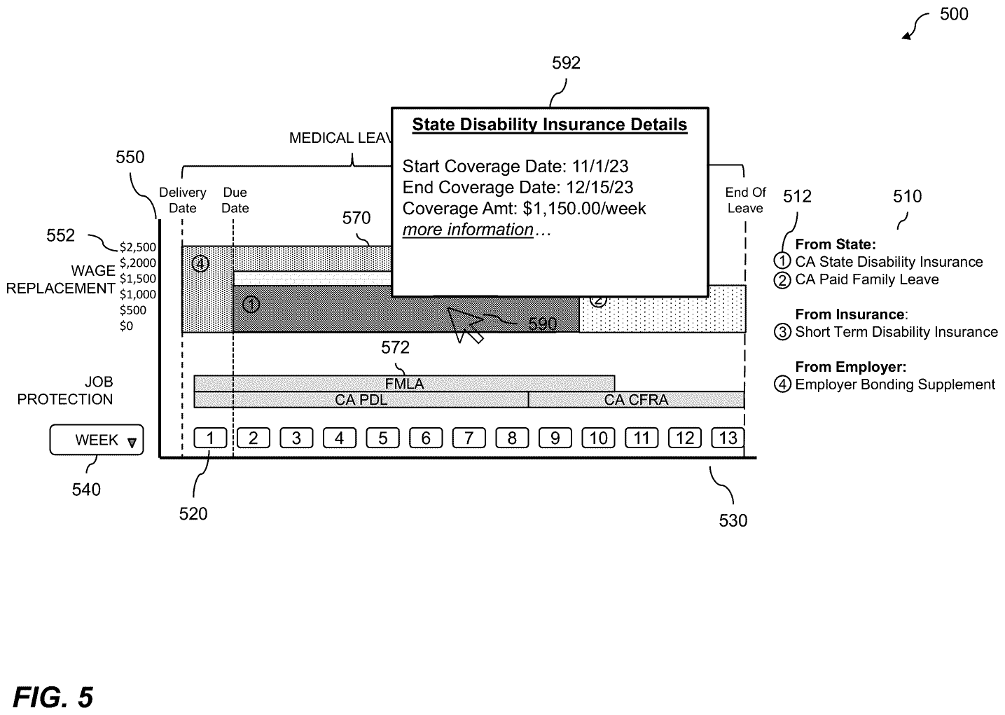

FIG. 5 is an example 500 of a mouse-over pop-up. The example 500 can include a list of user-qualified compensation factors 510. The factors can be listed in sequence order that can be determined by the MEA calculations. In the example, the list of compensation factors can be separated by source such as state, insurance, and employer. A number 512 can be associated with each compensation factor to indicate the priority sequence of each factor. The number can also be used as a key to the graph in order to indicate which compensation factor appears in each section of the graph. Colors or shading can be used as the key instead of numbers. In some embodiments, the qualifications, policies, and restrictions related to each compensation factor can be displayed beside each factor and can be presented as a drop-down list from the compensation factor label, as a separate detail page, as a window displayed over the main graph, and so on.

In embodiments, the selected user priorities, related compensation factors, and total time related to the applied compensation factors can be used to determine the x- and y-scale options displayed on the graph, as well as the order in which the compensation factors are displayed. In the example 500, the graph can display time periods 520 in weeks along the x-axis 530. Each time period can be numbered, starting with the week in which the selected compensation factors begin to be paid to the user. In the example of 500, the initial obstetric delivery date of the first compensation factor is shown as the beginning of the first week of compensation as a vertical dashed line. The due date for the first compensation factor to be used (the employer bonding supplement) is indicated as a vertical dotted line. The end-of-leave date is also indicated as a vertical dashed line on the right side of the graph. Note that other benefit plans can feature leaves that start before or after the due date. The user can select different time periods 540 for the x-axis display, such as days, weeks, months, and so on. Depending on the total length of the compensation period, the graph can automatically be displayed using the time increment that covers the entire length of the compensation factors. The user can select different time periods dynamically, allowing for more or less detail to be displayed.

The graph 500 can include a y-axis 550 that can describe two different graph sections. An upper section can indicate wage replacement in a currency such as dollars. The wage replacement currency scale is shown on the left 552, and the various sources of compensation are shown as numbered bars 570 across a number of weeks. The horizontal length of each graph bar can indicate the number of weeks, months, pay periods, etc. for which the particular compensation factor pays out. In embodiments, the lower section of the graph can display job protection elements 572. The job protection elements can be seen as grey bars running along the x-axis for various numbers of weeks. In the example graph, three separate job protection compensation elements are shown, each using a separate abbreviation. The California state pregnancy disability leave act is shown as CA PDL, the California state family rights act is shown as CA CFRA, and the federal family and medical leave act is shown as FMLA. In some embodiments, each compensation factor can be shown in a different color or pattern on the graph. In some embodiments, one or more brackets can be used at the top of the graph to indicate the start and end point of general categories of time off, such as medical leave and bonding leave.

The graph 500 can include a mouse pointer 590. In embodiments, the mouse pointer can be used to select portions of the graph in order to gather additional details. In the example 500, the mouse pointer can be used to select graph bar number one near the middle of the graph. The list of user-qualified compensation factors on the right side of the graph indicates that graph bar one represents CA State Disability Insurance. In embodiments, selecting a graph bar can create a mouse-over pop-up text window 592 containing additional details related to the selected compensation factor. The additional details can include a summary of each discrete time period, including total monetary compensation, compensation sources, job protection compensation factors in force, and so on. In embodiments, the additional details are displayed based on a daily benefit including a daily payment estimate. In the example 500, the mouse-over pop-up text window contains details related to the State Disability Insurance compensation factor, including the title of the compensation factor, the coverage start and end date, and the coverage amount in dollars per week. The user can move the mouse pointer to any bar displayed on the graph and collect similar information by clicking on the desired graph bar. Mouse clicking on a job protection graph bar can display details regarding the compensation program, the start and end date of coverage, and so on. In embodiments, the mouse-over pop-up text window includes weekly data when a week time period is selected. In embodiments, the weekly data shows a date range for the week corresponding to the location of the mouse-over rather than the start and end coverage dates as shown. In other embodiments, daily information is shown in the mouse-over pop-up text window when a daily time period is selected. The daily information can include daily benefit amount. In some embodiments, the start and end dates are not shown in the mouse-over pop-up text window.

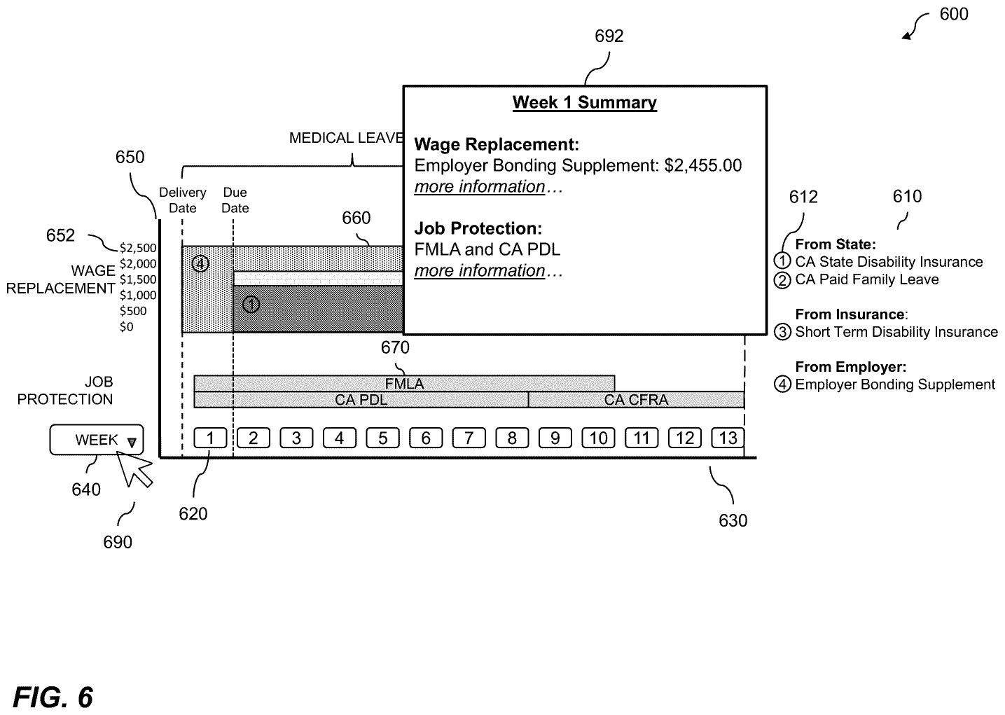

FIG. 6 is an example 600 of a week summary. As described previously, the graph 600 can include a list of user-qualified compensation factors 610. The factors can be listed in sequence order that can be determined by the MEA calculations. In the example, the list of compensation factors can be separated by source such as state, insurance, and employer. A number 612 can be associated with each compensation factor to indicate the priority sequence of each factor. The number can also be used as a key to the graph in order to indicate which compensation factor appears in each section of the graph. Colors or shading can be used as the key instead of numbers. The qualifications, policies, and restrictions related to each compensation factor can be displayed beside each factor, can be presented as a drop-down list from the compensation factor label, as a separate detail page, as a window displayed over the main graph, and so on.

In embodiments, the selected user priorities, related compensation factors, and total time related to the applied compensation factors can be used to determine the x- and y-scale options displayed on the graph, as well as the order in which the compensation factors are displayed. In the example 600, the graph can display time periods 620 in weeks along the x-axis 630. Each time period can be numbered, starting with the week in which the selected compensation factors begin to be paid to the user. The initial delivery date of the first compensation factor is shown as the beginning of the first week of compensation and can be indicated by a vertical dashed line. The due date for the first compensation factor to be used (the employer bonding supplement) is indicated as a vertical dotted line. The end-of-leave date is also indicated as a vertical dashed line on the right side of the graph. Note that other benefit plans can feature leaves that start before or after the due date. The user can select different time periods for the x-axis display, such as days, weeks, months, etc. Depending on the total length of the compensation period, the graph can automatically be displayed using the time increment that covers the entire length of the compensation factors. The user can select different time periods 640 dynamically, allowing for more or less detail to be displayed.

The graph 600 can include a y-axis 650 that can describe two different graph sections. The upper section can indicate wage replacement in a currency such as dollars. The wage replacement currency scale is shown on the left 652, and the various sources of compensation are shown as numbered horizontal bars 660 across a number of weeks. The horizontal length of each graph bar can indicate the number of weeks for which the particular compensation factor pays out. In embodiments, the lower section of the graph can display job protection elements 670. The job protection elements can be seen as grey bars running along the x-axis for various numbers of weeks. In the example graph, three separate job protection compensation elements are shown, each using a separate abbreviation. The California state pregnancy disability leave act is shown as CA PDL, the California state family rights act is shown as CA CFRA, and the federal family and medical leave act is shown as FMLA. In some embodiments, each compensation factor can be shown in a different color or pattern on the graph. In some embodiments, one or more brackets can be used at the top of the graph to indicate the start and end point of general categories of time off, such as medical leave and bonding leave.

The graph 600 can include a mouse pointer 690. In embodiments, the mouse pointer can be used to select portions of the graph in order to gather additional details. In the example 600, the mouse pointer can be used to select the time period indicator 640 located at the bottom left corner of the graph. The label in the time period indicator can display the time unit in use, for example weeks. In embodiments, selecting the time period indicator can create a pop-up text window 692 containing additional details related to the time period. The additional details can include a summary of each discrete time period, including total monetary compensation, compensation sources, job protection compensation factors in force, and so on. In the example 600, the pop-up text window contains details related to the first week of compensation, including the wage replacement compensation factor, the total dollars received, and the job protection factors in force during the week. In some embodiments, as time progresses through additional weeks, the user can move the mouse pointer to a week indicator along the x-axis of the graph and see a weekly summary for each week selected. In other embodiments, a summary of each month or each day can be displayed in the pop-up text window, based on the time period frequency selected by the user.

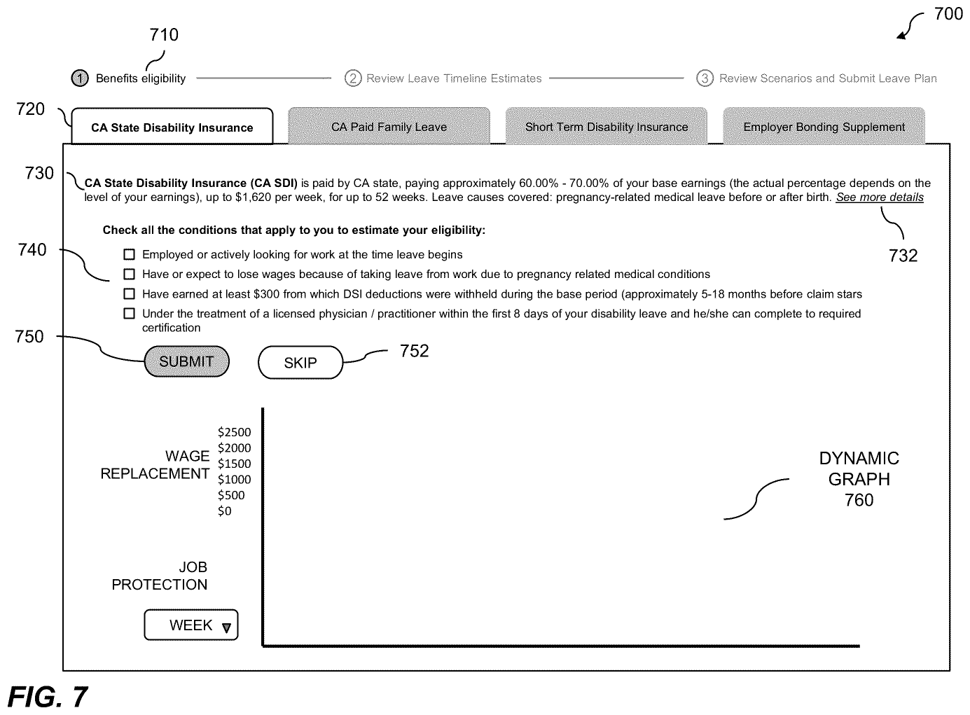

FIG. 7 is an example 700 of a graphical user interface. Recall that personal information, which comprises a user configuration and a first priority, can be gathered. In embodiments, the gathering includes a graphical user interface (GUI). The example 700 can include one or more progress stages 710. The progress stages can use text to indicate to the user a series of instructions to be taken in order to qualify and apply for various compensation factors. As indicated above and throughout, the GUI can include questions to gather information that can be used to determine compensation factors for which the user is qualified. The user can indicate a first priority for the compensation factors. For example, the user can choose to select and sequence compensation factors in order to allow for the highest amount of time off. Another user can choose to select compensation factors so as to collect the highest amount of wage replacement dollars, and so on. The user does not need to specify a first priority. In embodiments, the first priority is assumed. The progress stage example can include benefits eligibility, review leave timeline estimates, review scenarios and submit benefits plan, and other information. The GUI in the example 700 is shown displaying information related to the first progress stage, benefits eligibility.

The example 700 can include display tabs 720 that can be selected by the user to show details related to each compensation factor for which the user can qualify. Each compensation factor display tab can include a text title located along the top of the GUI window. In the example 700, the first user-qualified compensation factor, CA State Disability Insurance, has been selected. Details related to the selected compensation factor are shown below the display tab, including a title, abbreviation, and description of the compensation factor 730, a shortcut to display a secondary window of more detailed information about the compensation factor 732, and a list of conditions related to the compensation factor. In embodiments, the GUI includes a series of questions to be answered by the user. A list of conditions 740 can be updated by the user to indicate which conditions apply to the user. In the example 700, four conditions related to user eligibility for the CA State Disability Insurance compensation factor are displayed. Other conditions can be specified according to the compensation factor selected. The list of conditions can be customized. Embodiments include customizing the GUI, wherein the customizing is based on the usage configuration. The user can use a mouse pointer to check any or all of the conditions in the checkbox shown beside each condition description. Some embodiments include initializing the GUI, wherein the initializing includes one or more default answers to one or more questions in the series of questions. Some of the checkboxes can be preselected, based on the personal information that is collected, the usage configuration, a saved profile, an MEA, a saved MEA, and so on. Once the user has selected the checkboxes, the submit button 750 can be mouse-clicked, sending the condition information to the multivariate empirical algorithm (MEA) that has been generated for the user. The user can also elect to skip submission of the condition information for a particular compensation factor by mouse-clicking the skip button 752. In some embodiments, the user can select a different compensation factor tab and input condition information, submit the information, and then select another compensation factor tab to input condition information. In other words, the user can input compensation factor eligibility information into the GUI in any order desired.

The example 700 can include a dynamic graph 760. The dynamic graph can display a visual demonstration of each of the one or more user-qualified compensation factors, wherein the visual demonstration includes a total benefit payment estimate and a total benefit time duration. As the user submits condition information related to their eligibility for each compensation factor, the dynamic graph can be updated to display the resulting compensation factor information. For example, after the CA State Disability Insurance eligibility information is submitted, the dynamic graph can display a bar to indicate the number of weeks the compensation factor will be used, and the number of dollars of wage replacement the compensation factor will provide. A key to the right of the graph can indicate which compensation factor on the graph bar can be displayed. As the user submits additional eligibility condition information for each compensation factor, the dynamic graph can be updated to show a bar related to each compensation factor, any overlap between the various factors, the length of time in weeks for which each factor is active, and the wage replacement dollars related to each compensation factor. Thus, the user can get immediate feedback related to each compensation factor as well as the aggregate effect of all compensation factors for which the user qualifies.

The example 700 can include additional GUI display windows 710 that allow the user to review leave timeline estimates and alternate compensation scenarios, and a button to allow the user to select the one or more compensation factors to bundle into a benefit plan, which can be a leave plan. As indicated above and throughout, the user can generate additional MEAs based on alternate priorities, timelines, and other user information. The user can compare each set of leave plan results by filling out the benefits eligibility conditions information for each MEA alternative and viewing the resulting leave plan. Once the user has reviewed the alternatives and selected the desired leave plan, the user can submit the leave plan and begin completing the steps necessary to apply for each of the related compensation factors.

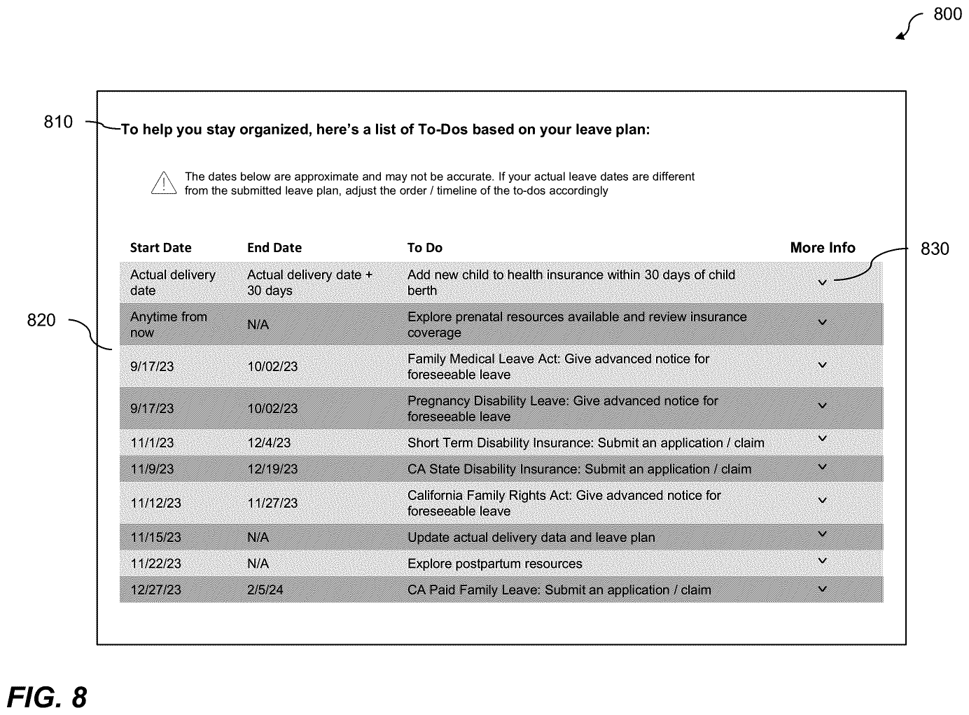

FIG. 8 is an example of application steps. The example 800 can include a general introduction to the page 810. The general introduction can explain to the user the list of to-do items and help the user to update timelines and the order of steps if necessary. The example 800 can include a detailed list of application steps 820. Some embodiments include displaying instructions, to the user, wherein the instructions include one or more application steps, to be accomplished by the user, for the one or more user-qualified compensation factors that were sequenced. The list of application steps can be displayed based on the compensation factors generated by the MEA and the user priority. In embodiments, the one or more application steps include an order, wherein the order is based on the sequencing. The list of application steps can include a drop-down option 830 that can include more detailed information regarding each application step. The additional details can include information about the policies and regulations related to the application step, shortcuts to internal or external websites with electronic forms, help desk information, user forums, and so on. When the actual date each step is completed, a date of acknowledgement from the associated compensation factor provider, a date of initial benefit payment, etc. can be included in the list of application steps. The end date can be adjusted based on the actual start date as the user updates each to-do list item. Some embodiments include reminding the user to accomplish the one or more application steps. The reminding can include a text, email, phone call, and so on. The reminding can be set for a date ahead of an end date of an application step. The user can set the date.

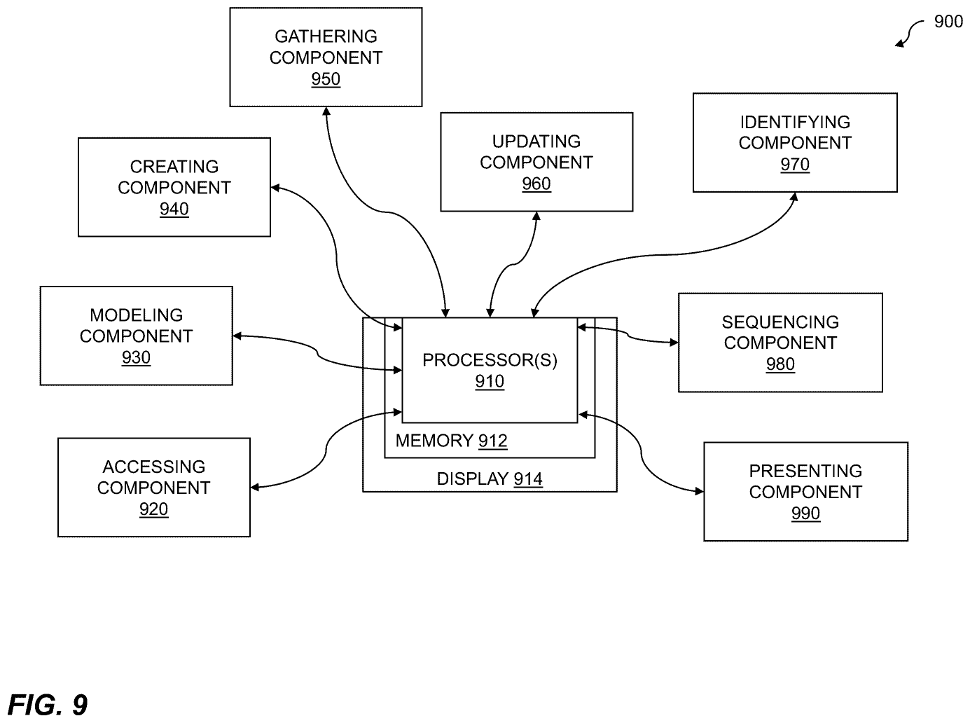

FIG. 9 is a system diagram 900 for multivariate optimization of compensation analytics. The system 900 can include one or more of processors, memories, cache memories, displays, and so on. The system 900 can include one or more processors 910. The processors can include standalone processors within integrated circuits or chips, processor cores in FPGAs or ASICs, and so on. The one or more processors can be coupled to a memory 912 which stores instructions. The system 900 can include a display 914 coupled to the one or more processors for displaying data, database information, programming details, intermediate steps, instructions, benefit information, compliance information, and so on. In embodiments, one or more processors 910 are attached to the memory 912 where the one or more processors, when executing the instructions which are stored, are configured to: access a policy database, wherein the policy database includes a plurality of policies, wherein each policy in the plurality of policies includes a plurality of benefit information and a plurality of compliance requirements, and wherein the plurality of benefit information is interrelated by the plurality of compliance requirements; model, with a plurality of mathematical formulas, the plurality of benefit information and compliance requirements; create a multivariate empirical algorithm (MEA), wherein the multivariate empirical algorithm arithmetically links one or more mathematical formulas within the plurality of mathematical formulas, and wherein the arithmetical links are based on a usage configuration within a plurality of usage configurations; gather, from a user, personal information, wherein the personal information comprises a user configuration, and wherein the personal information includes a first priority; update the MEA, wherein updating is based on the user configuration; identify, using one or more processors, one or more user-qualified compensation factors, wherein identifying is based on the MEA; sequence the one or more user-qualified compensation factors, wherein sequencing optimizes the one or more user-qualified compensation factors for the first priority; and present, to the user, the one or more user-qualified compensation factors that were sequenced, wherein presenting includes a visual demonstration of a payment estimate and a duration estimate of each of the one or more user-qualified compensation factors, and wherein the visual demonstration includes a total benefit payment estimate and a total benefit time duration.

The system 900 can include an accessing component 920. The accessing component 920 can include functions and instructions for accessing a policy database, wherein the policy database can include a plurality of policies, wherein each policy in the plurality of policies can include a plurality of benefit information and a plurality of compliance requirements, and wherein the plurality of benefit information can be interrelated by the plurality of compliance requirements. In embodiments, the plurality of benefit information and the plurality of compliance requirements include one or more private employer benefit plans, one or more local benefit plans, one or more state benefit plans, one or more federal benefit plans, one or more union plans, or a combination thereof. In some embodiments, the compliance requirements include eligibility requirements. The policies can include wages and tips; regular pay; overtime; holiday pay; hazard pay; commissions; bonuses; full-time, part-time, and temporary employee definitions; exempt and non-exempt employee status; tax policies; health, life, and disability insurance options; retirement plans; time off; flexible work hours; on-campus and off-campus employment; education assistance; wellness programs; and so on. The compliance requirements can include age restrictions, federal and state definitions of employee status, equal pay regulations, family and medical leave rules, equal opportunity guidelines, union rules, and so on.

The system 900 can include a modeling component 930. The modeling component 930 can include functions and instructions for modeling, with a plurality of mathematical formulas, the plurality of benefit information and compliance requirements. The modeling can represent, in mathematical equations, relevant benefit information and related compliance requirements. The mathematical formulas can contain any number of variables pertaining to the benefit modeled including a projected obstetric delivery date, time employed, salary level, and so on. The mathematical formulas can be combined to determine eligibility, application timing, length of benefits, dollar values of benefits, and so on.

The system 900 can include a creating component 940. The creating component 940 can include functions and instructions for creating a multivariate empirical algorithm (MEA), wherein the multivariate empirical algorithm arithmetically links one or more mathematical formulas within the plurality of mathematical formulas, and wherein the arithmetical links are based on a usage configuration within a plurality of usage configurations. The MEA can include a plurality of formulas that calculate industry, state, or federal compensation factors. In embodiments, the multivariate empirical algorithm includes a theoretical algorithm. The MEA formulas can be filtered out or selected for use based on compensation factors made available by the employer or the location in which the user lives or works. A library of usage configurations is described and stored based on widespread employee situations. For example, descriptions can be built for salaried full-time employees, part-time swing-shift employees, sales employees working on commission, full-time employees with chronic illnesses, and so on. In embodiments, the usage configuration within the plurality of usage configurations pertains to an employer or leave administrator. In embodiments, the leave administrator can include an insurance company or a third-party leave administrator. The number of mathematical formulas included in the MEA can be restricted to ensure that only those mathematical formulas that relate to a selected usage configuration are included.

The system 900 can include a gathering component 950. The gathering component 950 can include functions and instructions for gathering, from a user, personal information, wherein the personal information comprises a user configuration, and wherein the personal information includes a first priority. In embodiments, the gathering can include a graphical user interface (GUI). A GUI can be a system of interactive visual components for computer software, such as icons, cursors, buttons, file folders, arrows, menus, dialog boxes, toolbars, and so on. The visual objects represent actions that can be taken by the user and can change color, size, or visibility as the users interact with them. In embodiments, the GUI can include a series of questions to be answered by the user. The questions can include information such as name, birthdate, due date, gender, parental role, employer, job title, dependents, and so on. These can be included in the user configuration. The questions can include a first priority for compensation features. The first priority can be included in the user configuration. For instance, a user may want to maximize the amount of monetary compensation, even if the number of days out of the office is reduced. In some embodiments, the gathering includes a second priority. The user can choose to set up multiple scenarios with different priorities assigned to each and then compare them in later steps.

The system 900 can include an updating component 960. The updating component 960 can include functions and instructions for updating the multivariate empirical algorithm, wherein the updating is based on the user configuration. The selections made by the user and stored in the user configuration can be employed to further refine which mathematical formulas are used within the MEA for the user, and which formulas are not. The selections made by the user can be accomplished with the GUI. In response, the MEA can include or remove certain formulas related to those benefits. Embodiments include revising, by the user, the personal information. For example, the user can change the expected delivery date of a baby or method of delivery. The user can change the personal information at any time. The revising can be made in a GUI interface as previously described. Recall also that the MEA can be updated based on a user configuration. The MEA can be modified based on the change to the updating the personal information. Further embodiments include amending the visual demonstration, wherein the amending is responsive to the revising. As the user changes the personal information, and the resulting MEA is updated, the graph can be amended to show the results of the updated MEA to the user. The amending can include one or more compensation factors. The amending can include changing a color or pattern of one or more compensation factors. The amending can include compensation amounts, timelines, sources of monetary compensation, job-protected time available, and so on. By amending the graph, the user can see how changing information and assumptions can change the compensation factors associated with their planning scenario. Other embodiments include saving the MEA. The MEA that resulted from the set of responses from the user can be stored and compared with a different MEA created from updated responses that comprise a different plan scenario. Multiple scenarios with multiple MEAs can be saved and compared so the user can finetune the benefits he or she desires. The various MEAs can be used to present options to the user and to compare predicted results to actual results.

The system 900 can include an identifying component 970. The identifying component 970 can include functions and instructions for identifying, using one or more processors, one or more user-qualified compensation factors, wherein the identifying is based on the multivariate empirical algorithm. The user configuration and the updated MEA can be used to identify one or more compensation factors for which the user is qualified. The user configuration can be combined with the MEA to select from the policy database the policies, compensation options, and related compliance requirements that can be applied to the user's particular circumstances. The user configuration can be based on usage configurations that have been designed to address common user situations, such as the birth or adoption of a child, qualifying for federal Medicare plans, attending school while working, and so on.

The system 900 can include a sequencing component 980. The sequencing component 980 can include functions and instructions for sequencing the one or more user-qualified compensation factors, wherein the sequencing optimizes the one or more user-qualified compensation factors for the first priority. Some user configurations can result in multiple compensation programs being available, such as medical and bonding leave during the birth of a child. Properly sequencing the order of the one or more user-qualified compensation factors can influence which benefits the user actually receives. Company policies and programs can overlap with state or federal programs. In some configurations, the employer may limit the amount of time off or may extend it. In some configurations, time off for medical recovery from giving birth can be combined with bonding compensation programs, and so on. In some circumstances, the order in which the compensation programs are applied can impact the total amount of time off available to the user, or the total monetary compensation available. The MEA calculations can be used to optimize the order in which the user-qualified factors are applied, based on the first user priority.

The system 900 can include a presenting component 990. The presenting component 990 can include functions and instructions for presenting, to the user, the one or more user-qualified compensation factors that were sequenced, wherein the presenting includes a graph, wherein the graph comprises a visual demonstration of a payment estimate and a duration estimate of each of the one or more user-qualified compensation factors, and wherein the visual demonstration includes a total benefit payment estimate and a total benefit time duration. The presentation can include the list of user-qualified compensation factors, listed in sequence order that can be determined by the MEA calculations. The related qualifications, policies, and restrictions can be displayed beside each factor, or can be presented as a drop-down list, a separate detail page, or a window displayed over the main graph, and so on. A graph displaying time in days, weeks, months, and so on can be presented along with each compensation factor shown in a different color or pattern, etc. In embodiments, the user can move a mouse pointer over each compensation factor to view additional details related to that factor, such as the total number of days or weeks available, the start and end date, the amount of monetary compensation, and so on. The graph can include the sources of monetary compensation, including employer, local, state, federal, or union programs involved. The graph can include the total amount of job-protected time available, with or without monetary compensation.

The system 900 can include a computer program product embodied in a non-transitory computer readable medium for optimization, the computer program product comprising code which causes one or more processors to perform operations of: accessing a policy database, wherein the policy database includes a plurality of policies, wherein each policy in the plurality of policies includes a plurality of benefit information and a plurality of compliance requirements, and wherein the plurality of benefit information is interrelated by the plurality of compliance requirements; modeling, with a plurality of mathematical formulas, the plurality of benefit information and compliance requirements; creating a multivariate empirical algorithm (MEA), wherein the multivariate empirical algorithm arithmetically links one or more mathematical formulas within the plurality of mathematical formulas, and wherein the arithmetical links are based on a usage configuration within a plurality of usage configurations; gathering, from a user, personal information, wherein the personal information comprises a user configuration, and wherein the personal information includes a first priority; updating the multivariate empirical algorithm, wherein the updating is based on the user configuration; identifying, using one or more processors, one or more user-qualified compensation factors, wherein the identifying is based on the multivariate empirical algorithm; sequencing the one or more user-qualified compensation factors, wherein the sequencing optimizes the one or more user-qualified compensation factors for the first priority; and presenting, to the user, the one or more user-qualified compensation factors that were sequenced, wherein the presenting includes a visual demonstration of a payment estimate and a duration estimate of each of the one or more user-qualified compensation factors, and wherein the visual demonstration includes a total benefit payment estimate and a total benefit time duration.

Each of the above methods may be executed on one or more processors on one or more computer systems. Embodiments may include various forms of distributed computing, client/server computing, and cloud-based computing. Further, it will be understood that the depicted steps or boxes contained in this disclosure's flow charts are solely illustrative and explanatory. The steps may be modified, omitted, repeated, or re-ordered without departing from the scope of this disclosure. Further, each step may contain one or more sub-steps. While the foregoing drawings and description set forth functional aspects of the disclosed systems, no particular implementation or arrangement of software and/or hardware should be inferred from these descriptions unless explicitly stated or otherwise clear from the context. All such arrangements of software and/or hardware are intended to fall within the scope of this disclosure.

The block diagrams and flowchart illustrations depict methods, apparatus, systems, and computer program products. The elements and combinations of elements in the block diagrams and flow diagrams show functions, steps, or groups of steps of the methods, apparatus, systems, computer program products and/or computer-implemented methods. Any and all such functions-generally referred to herein as a “circuit,” “module,” or “system”—may be implemented by computer program instructions, by special-purpose hardware-based computer systems, by combinations of special purpose hardware and computer instructions, by combinations of general-purpose hardware and computer instructions, and so on.

A programmable apparatus which executes any of the above-mentioned computer program products or computer-implemented methods may include one or more microprocessors, microcontrollers, embedded microcontrollers, programmable digital signal processors, programmable devices, programmable gate arrays, programmable array logic, memory devices, application specific integrated circuits, or the like. Each may be suitably employed or configured to process computer program instructions, execute computer logic, store computer data, and so on.

It will be understood that a computer may include a computer program product from a computer-readable storage medium and that this medium may be internal or external, removable and replaceable, or fixed. In addition, a computer may include a Basic Input/Output System (BIOS), firmware, an operating system, a database, or the like that may include, interface with, or support the software and hardware described herein.

Embodiments of the present invention are limited to neither conventional computer applications nor the programmable apparatus that run them. To illustrate: the embodiments of the presently claimed invention could include an optical computer, quantum computer, analog computer, or the like. A computer program may be loaded onto a computer to produce a particular machine that may perform any and all of the depicted functions. This particular machine provides a means for carrying out any and all of the depicted functions.

Any combination of one or more computer readable media may be utilized including but not limited to: a non-transitory computer readable medium for storage; an electronic, magnetic, optical, electromagnetic, infrared, or semiconductor computer readable storage medium or any suitable combination of the foregoing; a portable computer diskette; a hard disk; a random access memory (RAM); a read-only memory (ROM); an erasable programmable read-only memory (EPROM, Flash, MRAM, FeRAM, or phase change memory); an optical fiber; a portable compact disc; an optical storage device; a magnetic storage device; or any suitable combination of the foregoing. In the context of this document, a computer readable storage medium may be any tangible medium that can contain or store a program for use by or in connection with an instruction execution system, apparatus, or device.

It will be appreciated that computer program instructions may include computer executable code. A variety of languages for expressing computer program instructions may include without limitation C, C++, Java, JavaScript™, ActionScript™, assembly language, Lisp, Perl, Tcl, Python, Ruby, hardware description languages, database programming languages, functional programming languages, imperative programming languages, and so on. In embodiments, computer program instructions may be stored, compiled, or interpreted to run on a computer, a programmable data processing apparatus, a heterogeneous combination of processors or processor architectures, and so on. Without limitation, embodiments of the present invention may take the form of web-based computer software, which includes client/server software, software-as-a-service, peer-to-peer software, or the like.

In embodiments, a computer may enable execution of computer program instructions including multiple programs or threads. The multiple programs or threads may be processed approximately simultaneously to enhance utilization of the processor and to facilitate substantially simultaneous functions. By way of implementation, any and all methods, program codes, program instructions, and the like described herein may be implemented in one or more threads which may in turn spawn other threads, which may themselves have priorities associated with them. In some embodiments, a computer may process these threads based on priority or other order.

Unless explicitly stated or otherwise clear from the context, the verbs “execute” and “process” may be used interchangeably to indicate execute, process, interpret, compile, assemble, link, load, or a combination of the foregoing. Therefore, embodiments that execute or process computer program instructions, computer-executable code, or the like may act upon the instructions or code in any and all of the ways described. Further, the method steps shown are intended to include any suitable method of causing one or more parties or entities to perform the steps. The parties performing a step, or portion of a step, need not be located within a particular geographic location or country boundary. For instance, if an entity located within the United States causes a method step, or portion thereof, to be performed outside of the United States, then the method is considered to be performed in the United States by virtue of the causal entity.

While the invention has been disclosed in connection with preferred embodiments shown and described in detail, various modifications and improvements thereon will become apparent to those skilled in the art. Accordingly, the foregoing examples should not limit the spirit and scope of the present invention; rather it should be understood in the broadest sense allowable by law.

What is claimed is:

1. A processor-implemented method for optimization comprising:
accessing a policy database, wherein the policy database includes a plurality of policies, wherein each policy in the plurality of policies includes a plurality of benefit information and a plurality of compliance requirements, and wherein the plurality of benefit information is interrelated by the plurality of compliance requirements;
modeling, with a plurality of mathematical formulas, using one or more processors, the plurality of benefit information and compliance requirements;
creating a multivariate empirical algorithm (MEA), wherein the multivariate empirical algorithm arithmetically links one or more mathematical formulas within the plurality of mathematical formulas, and wherein the arithmetical links are based on a usage configuration within a plurality of usage configurations;
gathering, from a user, personal information, wherein the personal information comprises a user configuration, and wherein the personal information includes a first priority;
updating the multivariate empirical algorithm, wherein the updating is based on the user configuration;
identifying, using one or more processors, one or more user-qualified compensation factors, wherein the identifying is based on the multivariate empirical algorithm;
sequencing the one or more user-qualified compensation factors, wherein the sequencing optimizes the one or more user-qualified compensation factors for the first priority; and
presenting, to the user, the one or more user-qualified compensation factors that were sequenced, wherein the presenting includes a visual demonstration of a payment estimate and a duration estimate of each of the one or more user-qualified compensation factors, and wherein the visual demonstration includes a total benefit payment estimate and a total benefit time duration.

2. The method of claim 1 further comprising revising, by the user, the personal information.

3. The method of claim 2 further comprising establishing a second multivariate empirical algorithm, wherein the second multivariate empirical algorithm arithmetically links one or more mathematical formulas within the plurality of mathematical formulas, and wherein the arithmetical links are dynamically updated based on the revising.

4. The method of claim 3 wherein the identifying and the sequencing are based on the second MEA.

5. The method of claim 4 wherein the presenting is based on choosing, by the user, between the MEA and the second MEA.

6. The method of claim 2 further comprising amending the visual demonstration, wherein the amending is responsive to the revising.

7. The method of claim 1 wherein the sequencing comprises reducing the one or more user-qualified compensation factors, wherein at least two user-qualified compensation factors in the one or more user-qualified compensation factors are offset.

8. The method of claim 1 wherein the sequencing comprises stacking the one or more user-qualified compensation factors, wherein at least two user-qualified compensation factors in the one or more user-qualified compensation factors are overlapped.

9. The method of claim 1 wherein the presenting comprises alerting the user of unused user-qualified compensation factors.

10. The method of claim 1 wherein the plurality of usage configurations comprises a plurality of employer benefit policies.

11. The method of claim 1 wherein the visual demonstration comprises a graph of the one or more user-qualified compensation factors.

12. The method of claim 1 further comprising tracking, by a payment tracker, payments collected from the one or more user-qualified compensation factors.

13. The method of claim 12 further comprising comparing the payments collected from the one or more user-qualified compensation factors with a payment estimate of the one or more user-qualified compensation factors.

14. The method of claim 13 further comprising recalculating the payment estimate of at least one user-qualified compensation factor.

15. The method of claim 1 wherein the gathering includes a second priority.

16. The method of claim 15 wherein the sequencing optimizes the one or more user-qualified compensation factors for the first priority before the second priority.

17. The method of claim 1 further comprising renewing one or more mathematical formulas within the plurality of mathematical formulas.

18. The method of claim 17 wherein the renewing is based on a change in the plurality of benefit information.

19. The method of claim 17 wherein the renewing is based on a change in the plurality of compliance requirements.

20. The method of claim 1 further comprising validating the mathematical formulas, wherein the validating includes a database of established benefit scenarios.

21. The method of claim 1 further comprising displaying instructions, to the user, wherein the instructions include one or more application steps, to be accomplished by the user, for the one or more user-qualified compensation factors that were sequenced.

22. The method of claim 21 wherein the one or more application steps include an order, wherein the order is based on the sequencing.

23. The method of claim 1 further comprising suggesting benefits, to the user, wherein the suggesting is based on the gathering.

24. The method of claim 1 wherein the gathering includes a graphical user interface (GUI).

25. The method of claim 24 further comprising customizing the GUI, wherein the customizing is based on the usage configuration.

26. The method of claim 1 wherein the plurality of benefit information and the plurality of compliance requirements include one or more private employer benefit plans, one or more local benefit plans, one or more state benefit plans, one or more federal benefit plans, one or more union plans, or a combination thereof.

27. The method of claim 1 wherein the first priority includes an income level, time duration, or a combination of user-qualified compensation factors.

28. The method of claim 1 wherein the first priority is assumed.

29. The method of claim 1 wherein the usage configuration within the plurality of usage configurations pertains to an employer or leave administrator.

30. The method of claim 1 wherein the personal information that was gathered is not personally identifiable information (PII).

31. A computer program product embodied in a non-transitory computer readable medium for optimization, the computer program product comprising code which causes one or more processors to perform operations of:
accessing a policy database, wherein the policy database includes a plurality of policies, wherein each policy in the plurality of policies includes a plurality of benefit information and a plurality of compliance requirements, and wherein the plurality of benefit information is interrelated by the plurality of compliance requirements;
modeling, with a plurality of mathematical formulas, the plurality of benefit information and compliance requirements;
creating a multivariate empirical algorithm (MEA), wherein the multivariate empirical algorithm arithmetically links one or more mathematical formulas within the plurality of mathematical formulas, and wherein the arithmetical links are based on a usage configuration within a plurality of usage configurations;
gathering, from a user, personal information, wherein the personal information comprises a user configuration, and wherein the personal information includes a first priority;
updating the multivariate empirical algorithm, wherein the updating is based on the user configuration;
identifying, using one or more processors, one or more user-qualified compensation factors, wherein the identifying is based on the multivariate empirical algorithm;
sequencing the one or more user-qualified compensation factors, wherein the sequencing optimizes the one or more user-qualified compensation factors for the first priority; and
presenting, to the user, the one or more user-qualified compensation factors that were sequenced, wherein the presenting includes a visual demonstration of a payment estimate and a duration estimate of each of the one or more user-qualified compensation factors, and wherein the visual demonstration includes a total benefit payment estimate and a total benefit time duration.

32. A computer system for optimization comprising:
a memory which stores instructions;
one or more processors attached to the memory wherein the one or more processors, when executing the instructions which are stored, are configured to:
access a policy database, wherein the policy database includes a plurality of policies, wherein each policy in the plurality of policies includes a plurality of benefit information and a plurality of compliance requirements, and wherein the plurality of benefit information is interrelated by the plurality of compliance requirements;
model, with a plurality of mathematical formulas, the plurality of benefit information and compliance requirements;
create a multivariate empirical algorithm (MEA), wherein the multivariate empirical algorithm arithmetically links one or more mathematical formulas within the plurality of mathematical formulas, and wherein the arithmetical links are based on a usage configuration within a plurality of usage configurations;
gather, from a user, personal information, wherein the personal information comprises a user configuration, and wherein the personal information includes a first priority;
update the multivariate empirical algorithm, wherein the updating is based on the user configuration;
identify, using one or more processors, one or more user-qualified compensation factors, wherein identifying is based on the multivariate empirical algorithm;
sequence the one or more user-qualified compensation factors, wherein sequencing optimizes the one or more user-qualified compensation factors for the first priority; and
present, to the user, the one or more user-qualified compensation factors that were sequenced, wherein presenting includes a visual demonstration of a payment estimate and a duration estimate of each of the one or more user-qualified compensation factors, and wherein the visual demonstration includes a total benefit payment estimate and a total benefit time duration.
